(19) United States
(12) Patent Application Publication
(10) Pub. No.: US 2025/0363256 A1
(43) Pub. Date: Nov. 27, 2025

(54) COMPUTER SOFTWARE AND COMPUTER IMPLEMENTED METHOD FOR DESIGN OF A BUILDING

(71) Applicant: Jonathan Cole Harding, Denver, CO (US)

(72) Inventor: Jonathan Cole Harding, Denver, CO (US)

(21) Appl. No.: 18/672,002

(22) Filed: May 23, 2024

(51) Int. Cl. G06F 30/13; G06F 30/12

(52) U.S. Cl. CPC G06F 30/13; G06F 30/12

(57) ABSTRACT

The invention includes a computer implemented method that provides an incremental process for a user to design a structure such as a building. Another preferred embodiment includes a computer product with computer coded instructions executed by a computer that allows the user to visualize features of the design as the user makes various selections for the design in a software program. The software provides multiple user interfaces for a user to visualize interior, exterior, and landscape components of the design. The software further provides two and three-dimensional images of the selected components as they may appear in a final design. Functionality in the software allows for the user to make incremental adjustments to the components and design parameters are automatically adjusted to account for the adjustments so that no selected adjustment results in an unresolvable conflict with design parameters originally selected.

### FIELD OF THE INVENTION

The invention comprises computer implemented methods and computer program products related to designing a building to be constructed. More specifically, the invention relates to the methods and products that allow for a user to incrementally select numerous building parameters including interior and exterior features, as well as providing templates for the parameters that the user can select for the features based on preestablished user preferences.

### BACKGROUND OF THE INVENTION

In the field of architecture, vast improvements have been made with the advent of computer software that enables architects, engineers, and other personnel in the building and architecture industries, to more efficiently design man-made structures. Computer software also enabled architects and engineers to modify and update architectural plans without having to completely restart a design process for a particular structure.

While architectural software is well known, as well as engineering software, traditional software in these fields has been designed for use by such professionals, and a home buyer has not been able to use such software because of its technical complexity. Further, while software applications may exist to enable a user to select specific features of a building to be constructed, feature selection does not automatically result in consideration of other factors which may feature selection by the user infeasible. For example, a prospective home buyer may wish to select a specific type of exterior however, the covenants in the particular neighborhood may not allow such an exterior and any software application that may be used for the buyer selection does not have the automatic capability to deny the exterior feature select without an architect or engineer having to reference covenant documents. Further for example, a user may wish to select a specific type of structural support, such as decorative wooden beams; However, considering the home model that the user has selected, the decorative wooden beams, although offered as an option, are not capable being used within the selected home model because the use of wooden beams does not comply with county building codes.

Considering the vast complexities in building a home in which a buyer may be offered numerous design possibilities, there is a need for a computer implemented architectural and engineering software that provides the user with a great number of options in a custom home build, and such software automatically reconfigures other architectural and engineering parameters that enables the users selection for a particular criteria to be incorporated in the final build design. Further, there is a need for software that also provides an advisory to the user to prevent the user from making a parameter selection that would otherwise compromise the basic structural design that can be built within other hierarchical parameters previously selected such as total allowable cost and lot size. There is also a need for a software application that not only allows the user to select and modify numerous design features of a custom build, but also to provide visual representations of what the user has selected or may wish to modify so that the user can see the selections in a virtual environment.

One patent reference that discloses an automated building design methodology includes the U.S. Pat. No. 11,068,623 entitled “Automated building design guidance software that optimizes cost, energy, daylight, glare, and thermal comfort.” The method disclosed in this reference is a method of optimizing computer-implemented building design, that includes the following: defining one or more options for each building component; providing an energy use intensity versus cost optimization value for each option for a plurality of metrics: selecting a subset of the plurality of metrics applicable to each option; defining a metric vector for each metric through connecting the energy use intensity versus cost optimization value for each option; arranging each metric vector on a coordinate grid with an equal angle between each metric vector, constructing a two-dimensional polygon on an XY-plane by interconnecting for all the metric vectors the energy use intensity versus cost optimization value for each option; providing a performance value for each option for each metric vector based on a percentage the metric vector the associated option represents; and representing a fitness factor for each option as a function of each of the plurality of metrics.

Another patent reference that discloses an automated building design methodology includes the US Patent Publication No. 20190251210 entitled “Computer aided design for brick and block constructions and control software to control a machine to construct a building.” This reference teaches a computer aided design software for designing a building or other structure of brick construction, where in addition to the usual three dimensional modelling and rendering typical of CAD software, tabular data describing the spatial location and orientation of each brick is provided, including information regarding which bricks are cut to length so as to be shortened, and where they are located along each course, and which bricks are machined, drilled or routed for services or other special fittings. Data pertaining to this is compiled in a database for access by control software to control a brick laying machine to build a building or other structure from bricks. The database may receive via interface with a scanner data being a measure of the elevation of the footings and/or concrete pad that has been constructed according to the building plan and for each brick of the first course, to determine how much material must be machined off the bottom of each brick so that when the first course is laid, the tops of the bricks of the first course are at the same level. This machining data is stored for each brick with the tabular data produced by computer aided design software, so that the control software can control the brick laying machine to machine and cut each brick as per the stored data and convey each brick to the stored position on the footing, pad or previously laid course of bricks, with application of adhesive prior to positioning of the brick.

Yet another patent reference that teaches automated building design and construction is the US Patent Publication No. 20100091015 entitled “Product, service, and market integration of three-dimensional modeling/rendering software for the construction, remodeling, manufacturing, designing, buying, and/or selling of homes, businesses, structures, vehicles, and/or buildings. This reference discloses processes geared towards the integration of products, services, and markets into 3D modeling/rendering software platforms. Users of 3D modeling/rendering software platforms will be able to implement over one thousand various products and services into 3D models/renderings of homes, businesses, vehicles, structures, and/or buildings. Users will also be able to send created and/or manipulated 3D models/renderings to a virtual marketplace where commercial entities specializing in construction, remodeling, manufacturing, designing, buying, and/or selling markets will compete for business opportunities related to 3D models/renderings of homes, businesses, vehicles, structures, and/or buildings.

While the prior art may be adequate for its intended purposes, there are numerous advantages and distinctions of the present invention as set forth in detail below.

### SUMMARY OF THE INVENTION

In accordance with the invention, according to one preferred embodiment, the invention comprises a computer implemented method especially configured for a prospective home buyer or builder (hereinafter also referred to as a “user”) to make a number of selections for specific features of a building to be built. According to another preferred embodiment of the invention, it includes a computer product that has computed coded instructions that are executed by a standard computer in which the computer includes a microprocessor, data storage, and one or more peripherals such as a visual monitor or screen that allows the user to visualize the custom build as the user makes various selections for a custom build.

According to one aspect of the invention, it is especially adapted for the creation of a design for a custom home. More specifically, the user is able to incrementally select numerous building parameters including interior and exterior features and as the user makes the selections, the method and product automatically adjust other parameters so that the currently selected parameter is able to be adopted within hierarchal parameters such as total cost, size, or other parameters that may ultimately restrict a specific parameter selected by the user.

According to another aspect of the invention, it provides templates or preconfigured modules which make up components of a custom build and wherein the modules are created based upon pre-established user preferences that are recorded and analyzed prior to the user making selections to build.

With respect to the computer implemented method of the invention, it may include the following basic steps or actions: (1) the user may be required to log in and create an account for security purposes; (2) the user is provided options to define property parameters, which may be an interactive visual display that allows the user to select a particular lot within a subdivision, or some other specified acreage of public record; (3) the user selects homeowner lifestyle attributes, enabling the computer implemented method to suggest custom build styles that may best fit the lifestyle of the homeowner; (4) optionally, the user may engage in a style inquiry in which the user selects a particular style for a room or area of the building, such as the particular style of a kitchen or dining room; (5) the user engages in a selection of homeowner requirements which may be presented to the user in a sliding scale that the user may manipulate on a user interface. The homeowner requirements may include sliding scales for the overall cost of the build, the number of bedrooms, the number of bathrooms, the square footage, and the number of floors in the build; (6) optionally, the user may engage in a homeowner preferences selection on a user interface in which the preferences are rated from a scale from such as 1 to 5, in which 5 is the most important.

The preferences may include rooms or spaces within the structure, or other attributes. From these user selections and preferences, the computer product of the invention will automatically generate visual representations of builds or designs that would be satisfactory to the user. For example, one user interface could display basic building styles or shells that have features that categorize the building styles in categories. For example, these basic styles or shells can be shown visually on a user interface with representative exterior views Another user interface could display exterior options in which the user may modify or adjust the exterior options. Another user interface could display a finalized exterior design which is a summation of the exterior selections made by the user during an interactive exterior selection process. Similarly, another user could display interior options in which the user may modify or adjust the interior options, and another user interface could display a finalized interior design as a summation of the interior selections.

From the user selections or preferences, The computer product of the invention also automatically generates proposed floor plans which comply with certain pre-selected parameters from the user, such as the range of square footage and the number of floors. The proposed floor plans can be presented in a side-by-side visual display on a user interface in which the user can view multiple floor plans that fall within the preselected parameters or preferences. The user may then select a particular floor plan and may also modify the selected floor plan in an interactive manner by moving the location of interior features including interior walls.

Another feature of the invention is the selection of a color palette shown on an interactive user display. The color palette includes options presented to the user for color combinations of both interior and exterior features of the build which match preselected criteria or parameters that the user may have selected during the style inquiry. The user may be presented with a plurality of color palettes that represent groups of colors to be incorporated within the interior and exterior features of the build.

Another feature of the invention is the selection of interior plumbing fixtures, cabinets, and furniture shown on an interactive user display. The user is provided with a plurality of menu options on corresponding user interfaces in which the user may select and modify each of the interior features.

Another feature of the invention is the selection of an interior design shown on an interactive user display. This step in the design process may include three-dimensional renderings that the user can view and move around virtually within the renderings.

Another feature of the invention is the selection of a desired landscape design shown on an interactive user display. This step in the design process may also include three-dimensional renderings so the user can view and move around virtually within the landscape renderings.

After the user has completed the aforementioned selection process, the computer product of the invention may display high quality renderings in three dimensions so the user can, in a virtual manner, see how the custom build will look when completed. At this stage, the user may return to any of the design selection steps in order to modify or change any selected feature or parameter of the custom build. Each time any change is made, the user will still be able to view a high-quality three-dimensional rendering of the changes as they may have been adopted in the final custom build.

There are numerous other features and advantages of the invention that will become apparent with a review of the following detailed description and figures. More specifically, the figures presented herein provide many user interfaces or screenshots that are available to be viewed by the user when operating the computer product of the invention. The user interfaces are highly interactive in which the user may incrementally select features of a custom build, and also may view selected features and changes as they are incorporated into the dynamic design.

According to one aspect of the invention, it may be considered a computer-implemented method for designing a custom building, wherein a user of the method desires to build or purchase the custom building to be built and said method enabling creation of a final design, said method comprising the steps of: providing a non-transitory computer-readable medium containing computer executable instructions, wherein, when executed by a computer processor, the instructions cause the computer processor to execute the method of designing the custom building, providing at least one database that is accessible by the computer processor and said at least one database having data objects that include at least one of (1) two-dimensional images of components of the building, (2) three-dimensional images of components of the building and (3) descriptions of components of the building, and said data objects being viewable on a plurality of user interface screens associated with the computer, and wherein said components include features of the building including at least one of interior features, exterior features, landscaping features, and floor plans of the building to be built; providing a plurality of user interfaces containing questions regarding details of the user preferences enabling the user to input preferences to the questions that are recorded in the at least one database, said questions including queries to the user as to specific attributes or styles that the user wishes to adopt in the design of the building; associated logic within the computer executable instructions that is responsive to the preferences submitted by the user wherein the preferences are matched with data objects that reflect the preferences; providing another user interface that shows at least one of the two or three-dimensional images of components of the building that include the matched data objects; providing another user interface that allows the user to change the preferences and subsequently resulting in another user interface provided that shows the changed preferences; executing instructions from the user to repetitively revise and to then finalize the design; and providing another user interface that allows the user to view three dimensional images of the final design.

According to yet another aspect of the invention, it may be considered a computer program product that executes a computer-implemented method for designing a custom building, wherein a user of the method desires to build or purchase the custom building to be built and said method enabling creation of a final design, said computer program product comprising: a non-transitory computer-readable medium containing computer executable instructions, wherein, when executed by a computer processor, the instructions cause the computer processor to execute the computer implemented method of the product; computer readable instructions to receive and store data in at least one database having data objects that correspond to two-dimensional and three-dimensional images of components of the building when viewed on a user interface screen associated with a display of a computer that incorporates said data processor, wherein said components include features of at least one of an interior, exterior, landscaping and floor plans of the building to be built; computer readable instructions to generate questions shown to the user regarding details of the building and these questions enabling a user to input preferences to the questions that are recorded in the at least one database, said questions including queries to the user as to specific attributes or styles that the user wishes to adopt in the design of the building; associated logic within the computer executable instructions that is responsive to the preferences submitted by the user wherein the preferences are matched with data objects that reflect the preferences; providing another user interface that shows at least one of the two or three-dimensional images of components of the building that include the matched data objects; providing another user interface that allows the user to change the preferences and subsequently resulting in another user interface provided that shows the changed preferences; executing instructions from the user to repetitively revise and to then finalize the design; and providing another user interface that allows the user to view three dimensional images of the final design.

According to yet another aspect of the invention, it may be considered a computer-implemented method for designing a custom building as directed by a user who executes the method to create a plurality of iterative intermediate designs and a final design, said method comprising the steps of: providing a non-transitory computer-readable medium containing computer executable instructions, wherein, when executed by a computer processor, the instructions cause the computer processor to execute the method of designing the custom building, providing at least one database that is accessible by the computer processor and said at least one database having data objects that corresponds to two-dimensional and three-dimensional images of components of the building when viewed on a user interface screen associated with the computer, wherein said components include features of at least one of an interior, exterior, landscaping and floor plans of the building to be built; providing a user interface with questions regarding details of the building and these questions enabling a user to input preferences to the questions that are recorded in the at least one database, said questions including queries to the user as to specific attributes or styles that the user wishes to adopt in the design of the building; associated logic within the computer executable instructions that is responsive to the preferences submitted by the user wherein the preferences are matched with data objects that reflect the preferences; providing another user interface that shows at least one of the two or three-dimensional images of components of the building that include the matched data objects; providing another user interface that allows the user to change the preferences and subsequently resulting in another user interface provided that shows the changed preferences, the changed preferences being viewable as intermediate designs; and executing instructions from the user to repetitively revise and to then finalize the design.

Optional aspects of the invention in accordance with any of the methods or computer products described above may include one or more of the following: (1) the data objects viewable by the user may include interior rooms of the custom building, exterior categorized design types, furniture, appliances, interior room arrangements shown as floor plans, color palettes, and landscape designs; (2) a user may upload photographs to the computer readable medium and the photographs become data objects so that the user may utilize the photographs as supplemental data objects for any one of the interior features, exterior features, landscaping features, and floor plans; (3) the computer readable medium includes logic which allows photo recognition such that uploaded photos can be identified as having distinct elements of corresponding data objects, and thus the distinct elements are can be incorporated within designs options for the user.

According to another aspect of the invention, it may be considered a computer-implemented method for designing a custom building, wherein a user of the method desires to build or purchase the custom building to be built and said method enabling creation of a final design, said method comprising the steps of: providing a non-transitory computer-readable medium containing computer executable instructions, wherein, when executed by a computer processor, the instructions cause the computer processor to execute the method of designing the custom building; providing at least one database that is accessible by the computer processor and said at least one database having data objects that include at least one of (1) two-dimensional images of components of the building, (2) three-dimensional images of components of the building and (3) descriptions of components of the building, said data objects being viewable on a plurality of user interface screens associated with the computer, and wherein said components include features of the building including at least one of interior features, exterior features, landscaping features, and floor plans of the building to be built; providing a plurality of data objects of two-dimensional images features of the building in said database that are recorded as corresponding to one or more specific styles, providing a plurality of user interfaces containing style questions to the user regarding details of user preferences for features to be incorporated in the building; recording the user preferences in at least one database wherein the questions may include two-dimensional images of the features of the building shown to the user on user interfaces; determining by said computer which images in said data base provide closest style matches as compared to the user preferences wherein the user preferences are numerically quantified as corresponding to one or more the data object styles recorded in the database; executing logic within the computer executable instructions that is responsive to preferences submitted by the user wherein the preferences are matched with data objects that match the user preferences; providing another user interface that shows at least one of the two or three-dimensional images of components of the building that include the matched data objects; providing another user interface that allows the user to change the preferences and subsequently resulting in another user interface provided that shows the changed preferences; executing instructions from the user to repetitively revise and to then finalize the preferences to create the final design; and providing another user interface that allows the user to view three dimensional images of the final design.

According to yet another aspect of the invention, it may be considered a computer-implemented method for designing features of a man-made structure having interior and exterior features that can be occupied by one or more persons, said method comprising the steps of: providing a non-transitory computer-readable medium containing computer executable instructions, wherein, when executed by a computer processor, the instructions cause the computer processor to execute the method of designing the structure; providing at least one database that is accessible by the computer processor and said at least one database having data objects that include at least one of (1) two-dimensional images of the structure, (2) three-dimensional images of components of the structure, and (3) descriptions of components of the structure, and said data objects being viewable on a plurality of user interface screens associated with the computer, and wherein said components include features of the structure including at least one of interior features and exterior features; providing a plurality of user interfaces containing questions regarding details of the user preferences enabling the user to input preferences to the questions that are recorded in the at least one database, said questions including queries to the user as to specific attributes or styles that the user wishes to adopt in the design of the structure; associated logic within the computer executable instructions that is responsive to the preferences submitted by the user wherein the preferences are matched with data objects that reflect the preferences; providing another user interface that shows at least one of the two or three-dimensional images of components of the structure that include the matched data objects; providing another user interface that allows the user to change the preferences and subsequently resulting in another user interface provided that shows the changed preferences; executing instructions from the user to repetitively revise and to then finalize a design of the structure wherein each revision automatically results in defined parameters being recalculated each time revisions are made, said parameters including at least one of a cost of the structure, a bill of materials for the structure, a square footage of the structure and a footprint of the structure as displayed in an exterior view of the structure or a floor plan of the structure.

According to the immediately aforementioned method, a number of optional features may be included. These optional features may comprise: a user selectable randomize tool on a user interface enabling a user to incorporate shell logic parameters for a chosen shell previously entered by the user to change attributes of the interior or exterior; a user selectable pan tool on a user interface enabling a user to pan and zoom around a virtual three-dimensional image of the interior or exterior of the structure; a user selectable size tool on a user interface enabling a user to modify the size, thickness of structural components of the interior or exterior and further wherein the user interface displays ae current size of the components and one or more selected size changes; a user selectable move tool on a user interface enabling a user to move components in the interior or exterior and wherein the move tool allows the move or inhibits the move if the movement goes beyond allowable design parameters; a user selectable place tool on a user interface enabling a user to place additional components on the interior or exterior and wherein the additional components are rendered on the user interface for the user to see; and a user selectable color tool on a user interface enabling a user to modify a color of a component or to modify other attributes of the component such as a type of finish, texture, or other visible characteristic.

According to yet another aspect of the invention, it may be considered a computer program product that executes a computer-implemented method for designing features of a man-made structure having interior and exterior features that can be occupied by one or more persons, said method comprising the steps of: a non-transitory computer-readable medium containing computer executable instructions, wherein, when executed by a computer processor, the instructions cause the computer processor to execute the computer implemented method of the product; computer readable instructions to receive and store data in at least one database having data objects that correspond to two-dimensional and three-dimensional images of components of the structure when viewed on a user interface screen associated with a display of a computer that incorporates said data processor, wherein said components include features of at least one of an interior and exterior of the structure; computer readable instructions to generate questions shown to the user regarding details of the structure and these questions enabling a user to input preferences to the questions that are recorded in the at least one database, said questions including queries to the user as to specific attributes or styles that the user wishes to adopt in the design of the structure; associated logic within the computer executable instructions that is responsive to the preferences submitted by the user wherein the preferences are matched with data objects that reflect the preferences; providing another user interface that shows at least one of the two or three-dimensional images of components of the structure that include the matched data objects; providing another user interface that allows the user to change the preferences and subsequently resulting in another user interface provided that shows the changed preferences; executing instructions from the user to repetitively revise and to then finalize the design.

According to the immediately aforementioned method, a number of optional features may be included. These optional features may comprise the tools described above including the randomize tool, the pan tool, the size tool, the move tool, the place tool, and the color tool.

According to any of the aforementioned method aspects of the invention, the methods may further include creating architectural plans and construction plans from the final design; and constructing the building from the architectural and construction plans.

According to any of the aforementioned method aspects of the invention, the methods may also further include creating landscaping plans from the final design; and creating landscaping for the building from the landscaping plans.

According to yet another aspect of the invention, it may be considered a computer-implemented method for designing features of a man-mad structure comprising: providing a non-transitory computer-readable medium containing computer executable instructions, wherein, when executed by a computer processor, the instructions cause the computer processor to execute the method of designing the custom building; providing at least one database that is accessible by the computer processor and said at least one database having data objects that include at least one of (1) two-dimensional images of components of the structure (2) three-dimensional images of components of the structure and (3) descriptions of components of the structure, and said data objects being viewable on a plurality of user interface screens associated with the computer, and wherein said components include features of the structure including at least one of interior features, exterior features, landscaping features, and floor plans of the structure to be built; providing a plurality of user interfaces containing questions regarding details of the user preferences enabling the user to input preferences to the questions that are recorded in the at least one database, said questions including queries to the user as to specific attributes or styles that the user wishes to adopt in the design of the structure; associated logic within the computer executable instructions that is responsive to the preferences submitted by the user wherein the preferences are matched with data objects that reflect the preferences and wherein the data objects are matched on a percentage basis to provide a most optimum match; providing another user interface that shows at least one of the two or three-dimensional images of components of the structure that include the matched data objects; executing instructions from the user to repetitively revise the design; and providing another user interface that allows the user to view three dimensional images of the design.

According to yet another aspect of the invention, it may be considered A computer program product that executes a computer-implemented method for designing features of a man-made structure, said computer program product comprising: a non-transitory computer-readable medium containing computer executable instructions, wherein, when executed by a computer processor, the instructions cause the computer processor to execute the computer implemented method of the product; computer readable instructions to receive and store data in at least one database having data objects that correspond to two-dimensional and three-dimensional images of components of the structure when viewed on a user interface screen associated with a display of a computer that incorporates said data processor, wherein said components include features of at least one of an interior and exterior of the structure to be built, computer readable instructions to generate questions shown to the user regarding details of the structure and these questions enabling a user to input preferences to the questions that are recorded in the at least one database, said questions including queries to the user as to specific attributes or styles that the user wishes to adopt in the design of the structure; associated logic within the computer executable instructions that is responsive to the preferences submitted by the user wherein the preferences are matched with data objects that reflect the preferences; wherein the user preferences and data objects are matched by a percentage basis in order to provide a best match; providing another user interface that shows at least one of the two or three-dimensional images of components of the structure that include the matched data objects; executing instructions from the user to repetitively revise the design; and providing another user interface that allows the user to view three dimensional images of the design.

It will be understood that while the invention may be especially adapted for the custom design and build of a home, the invention is not limited to the field of homes and the features of the invention can be used to custom design and build any interior space. For example, the invention is equally applicable to the custom design and build of a commercial building, an office building, or even the interior space of watercraft such as a cruise ship.

### BRIEF DESCRIPTION OF THE DRAWINGS

FIG. 1 is a flow diagram illustrating steps or actions according to the method of the invention;

FIG. 2 is a sample user interface or screen shot showing the user selection of a particular address and lot number that may be found in a local government real estate document and selected by the user as the specific address and area where the custom build is to take place;

FIG. 3 is a sample user interface or screen shot that is a query or quiz regarding the hobbies and interests of the user that is used to establish templates or suggestions for specific design features that match the user's hobbies and interests;

FIG. 4 is a sample user interface or screenshot that provides a style quiz for the user in which the user sees an image of a particular style for one or more rooms or areas of the building to be built, illustrated as options for a kitchen;

FIG. 5 shows two pie charts that are numeric expressions of what the kitchen options represent in FIG. 4. The representations are pre-identified style categories in which each of the kitchen options adopt a certain percentage of the pre-identified styles;

FIG. 6 is a sample user interface or screenshot that provides another example of a style quiz for another room or area of the building, illustrated as three style options for a living room;

FIG. 7 shows three pie charts that are numeric expressions of what the three living room options represent in FIG. 6.

FIG. 8 is a sample user interface or screenshot that allows for the user to upload to the computer product their own style photos which may include interior or exterior details of a building which they would like to adopt in the custom build;

FIG. 9 is a sample user interface or screenshot showing how the software of the invention uses an uploaded photo to classify and match the photo to existing exterior designs within a database of the software so that the uploaded photo can be used to present design options to the user;

FIG. 10 is a sample user interface or screenshot showing how the software of the invention uses an uploaded photo to classify and match the photo to existing interior designs within a database of the software so that the uploaded interior photo can be used to present design options to the user;

FIG. 11 is a pie chart that graphically illustrates the style quiz results showing example categories and the corresponding percentages of styles that are attributed to a user's selections in the style quiz;

FIG. 12 is a sample user interface or screenshot operated by a user in which the user selects building requirements that are the group of factors that will primarily determine the basic layout and style of the custom build, these requirements illustrated as sliding scales to be selected by the user for the cost of the build, the number of bedrooms, the number of bathrooms, the square footage, the number of floors, and one optional field that allows the user to select another category of requirement;

FIG. 13 is a sample user interface or screenshot operated by a user in which the user selects priorities as scaled from 1 to 5 in importance regarding interior rooms of the design;

FIG. 14 is a sample user interface or screenshot that displays the corresponding shells or basic design parameters that are automatically matched with the style quiz, property parameters, local building codes and any specific user preferences such as uploaded photos, wherein a plurality of images are representative cover images that convey the design title or tag that is assigned by the software;

FIG. 15 shows representative pie charts that indicate the compatibility of matched types of styles with user's preferences;

FIG. 16 is a sample user interface or screenshot that shows a representation or image of the selected design and shows multiple tools that allow a user to modify a pre-generated shell exterior and more specifically shows a revert tool that allows the user to revert or go back to the original shell design;

FIG. 17 is a sample user interface or screenshot that a representation or image of the selected design and shows the multiple tools, and more specifically shows a randomize tool that uses shell logic parameters for a chosen shell entered by the user in previous steps to change attributes of the exterior design;

FIG. 18 is a sample user interface or screenshot that shows a representation or image of the selected design and shows the multiple tools, and more specifically shows a pan tool that allows the user to pan and zoom around a virtual three-dimensional image of the exterior of the building;

FIG. 19 is a sample user interface or screenshot that shows a representation or image of the selected design and shows the multiple tools, and more specifically shows a size tool that allows a user to modify the size thickness of exterior structural components, this tool being capable of displaying the current size and the selected size change;

FIG. 20 is a sample user interface or screenshot that shows a representation or image of the selected design and shows the multiple tools, and more specifically shows a move tool that allows a user to move components in the design in which tool may allow the desired movement or inhibit the desired movement if the movement went beyond allowable design parameters;

FIG. 21 is a sample user interface or screenshot that shows a representation or image of the selected design and shows the multiple tools, and more specifically shows a place tool that allows a user to place additional components on the design and the additional components are rendered in the image of the exterior;

FIG. 22 is a sample user interface or screenshot that shows a representation or image of the selected design and shows the multiple tools, and more specifically shows a color tool that allows the user to modify the color of component or to modify other attributes of a component such as the type of finish, texture, or other visible characteristic;

FIG. 23 is a sample user interface or screenshot that shows a representation or image of the selected exterior design in its finalized form as determined by the user, noting that only the pan tool is shown which allows the user to view the finalized design;

FIG. 24 is a sample user interface or screenshot that shows the selected floor plan of a first floor in which there were three floor plans to select from;

FIG. 25 is a sample user interface or screenshot that allows a user to modify a floor plan, noting the first floor is selected for modification and in which the same tools are made available for modifying the floor plan as were available for modifying the exterior, namely, the revert tool which is selected in the FIG. 27 and the other tools are shown (randomize, size, move, and place tools and information);

FIG. 26 is a sample user interface or screenshot that shows a modification to be made to the first-floor plan and the user has selected the randomize tool;

FIG. 27 is a sample user interface or screenshot that shows a modification to be made to the first-floor plan and the user has selected the size tool;

FIG. 28 is a sample user interface or screenshot that shows a modification to be made to the first-floor plan and the user has selected the move tool;

FIG. 29 is a sample user interface or screenshot that shows a modification made to the first-floor plan and the user selected the move tool, and noting that the element that was moved (the stairway) resulted in the software to automatically re-draw the floor plan or expand other elements that would not fit in the floor plan as originally arranged by movement of the stairway;

FIG. 30 is a sample user interface or screenshot that shows a modification made to the first-floor plan and the user selected the move tool and noting that the software program issued an alert because a feature of the floorplan was moved to a location outside the authorized areas. The alert allows the user to undo the change or to continue with the change. If the user selects the continue option, another user interface may be shown that takes the user back to preselected criteria that may need to be changed in order to have the proposed change accepted in the final design;

FIG. 31 is a sample user interface or screenshot that shows a modification to be made to the first-floor plan and the user has selected the place tool;

FIG. 32 is a sample user interface or screenshot that shows a modification to be made to the first-floor plan and the user has selected the information tool;

FIG. 33 is a sample user interface or screenshot that shows a modification to be made to the first-floor plan and the user has selected the information tool to view information about a specific object in the first-floor plan;

FIG. 34 is a sample user interface or screenshot that shows a representation or image of the selected floor plan in its finalized form as determined by the user and in which the user selects the measure tool to measure a room;

FIG. 35 is a sample user interface or screenshot that shows a representation or image of the selected floor plan in its finalized form in which the user selects the measure tool to measure one element of the room, shown as the length of one wall;

FIG. 36 is a sample user interface or screenshot that shows a representation or image of the selected floor plan in its finalized form and in which the user selects the efficiency tool to obtain information on the movement efficiency within the depicted floor plan;

FIG. 37 is a sample user interface or screenshot that shows a representation or image of the selected floor plan in its finalized form and in which the user selects the efficiency tool to obtain information on the placement efficiency within the depicted floor plan;

FIG. 38 is a sample user interface or screenshot that shows a representation or image of the selected floor plan in its finalized form and in which the user selects the efficiency tool to obtain information on the size efficiency within the depicted floor plan,

FIG. 39 is a sample user interface or screenshot that shows a representation or image of the selected floor plan in its finalized form and in which the user selects the efficiency tool to obtain information on the natural light efficiency within the depicted floor plan;

FIG. 40 is a sample user interface or screenshot that shows a representation or image of the selected floor plan in its finalized form and in which the user selects the suggestions tool;

FIG. 41 is a sample user interface or screenshot that shows color palette options and a particular color palette selected by the user;

FIG. 42 is a sample user interface or screenshot that shows the selected color palette and changes to be made to the color palette in which the selected colors can be replaced or deleted;

FIG. 43 is a sample user interface or screenshot that shows options for selecting cabinets, plumbing fixtures and furniture;

FIG. 44 is a sample user interface or screenshot that shows one or more collections that may be selected for plumbing fixtures and including options for modifying a collection and to obtain additional information about a collection;

FIG. 45 is a sample user interface or screenshot that allows a user to modify the interior design and in which the same tools are made available for modifying the interior design as were available for modifying the exterior and modifying the floor plans, namely, the revert tool which is selected in the FIG. 45 and the other tools are shown (randomize, size, move, place and information tools);

FIG. 46 is a sample user interface or screenshot that shows the interior design modification, and the user has selected the pan tool;

FIG. 47 is a sample user interface or screenshot that shows the interior design modification, and the user has selected the move tool;

FIG. 48 is a sample user interface or screenshot that shows the interior design modification, and the user has selected the place tool;

FIG. 49 is a sample user interface or screenshot that shows the interior design modification, and the user has selected the color tool;

FIG. 50 is a sample user interface or screenshot that shows the interior design modification, and the user has selected the information tool that allows the user to modify the interior design by selecting an object on the screenshot such as a piece of furniture, fixture, or other interior design element. The depicted example in this figure shows selection of a barstool with the options to replace or delete the barstool;

FIG. 51 is a sample user interface or screenshot that allows a user to modify the landscape design and in which the same tools are made available for modifying the landscape design as were available for modifying the exterior, modifying the floor plans, and modifying the interior, namely, the revert tool that is selected and the other tools are also shown (randomize, size, move, place and information tools);

FIG. 52 is a sample user interface or screenshot that shows the landscape design modification, and the user has selected the pan tool;

FIG. 53 is a sample user interface or screenshot that shows the landscape design modification, and the user has selected the move tool;

FIG. 54 is a sample user interface or screenshot that shows the landscape design modification, and the user has selected the place tool;

FIG. 55 is a sample user interface or screenshot that shows the landscape design modification, and the user has selected the color tool;

FIG. 56 is a sample user interface or screenshot that shows the landscape design modification, and the user has selected the information tool; and

FIG. 57 is a sample user interface or screenshot that shows an option for the user to review and approve the entire final design for the interior, exterior, and landscaping, wherein functionality in this user interface allows a user to pan three-dimensional virtual images of the final design.

### DETAILED DESCRIPTION

The invention is described in preferred embodiments which include a computer implemented method and a computer program product. The invention may also be considered to include combinations and sub-combinations of the method and product.

With respect to the drawings, sample user interface or screenshots are provided to show the functionality of the invention. The invention is intended to provide detailed interaction with the user in which a user may incrementally design a building, make changes to the design, and view both two-dimensional and three-dimensional images of the selected design.

The computer coded instructions making up a software component of the invention includes logic which may govern the extent to which a desired user change or update is capable of being incorporated into the design based upon pre-established criteria or limits as to what the design can be. For example, the user may select a cost range for construction of the design. If the user selects an interior or exterior feature that would cause the construction cost to be outside of the limits of the cost range, then a user note or warning can be displayed on the user interface indicating to the user that be selected option causes the estimated construction cost to fall outside of the selected range limit. Accordingly, a database of the invention may include estimated material and labor costs that are associated with each option that the user may select in terms of a component of the custom build. Another example would be if a user selects to expand or move a wall or a floor of the design, and such a move would result in expanding the footprint of the building to the extent that it violates local zoning regulations or local building codes. Again, in this example, a user note or warning can be displayed on a user interface indicating to the user that the selection option causes a violation in a local zoning or building code, and therefore such a selection is not possible. In either example, there could also be an override function which will allow the user to adopt a change in the design such that the design is to incorporate the objected to feature but that the objected feature is noted in a report to be submitted to a licensed architect or engineer for their review and comment.

With respect to the interactive features of the invention, the user interfaces or screenshots illustrated herein are intended to show that the user can select one or more options on the particular user interface/screenshot and the user will subsequently view the executed action or will be provided another user interface for the user to make a further choice or to revert to a prior choice in an incremental design protocol.

The software of the invention may be operated within a general-purpose computer or mobile computing device (such as a mobile phone) (hereinafter collectively GPC devices) in which the GPC devices have elements that cooperate to achieve multiple functions normally associated with general purpose computers. For example, the hardware elements of the GPC may include one or more central processing units (CPUs) for processing data. The GPC may further include one or more input devices (e.g., a mouse, a keyboard, etc.); and one or more output devices (e.g., a display device, a printer, etc.). The GPC devices may also include one or more storage devices. By way of example, storage device(s) may be disk drives, optical storage devices, solid-state storage device such as a random-access memory (“RAM”) and/or a read-only memory (“ROM”), which can be programmable, flash-updateable and/or the like. In one functional aspect, an application server may create web pages dynamically for displaying the functionality associated with the system to include user interfaces that show the AR overlays.

Each of the GPC devices may include a computer-readable storage media reader; a communications peripheral (e.g., a modem, a network card (wireless or wired), an infra-red communication device, etc.); working memory, which may include RAM and ROM devices as described above.

The GPC devices may also comprise various software elements and an operating system and/or other programmable code such as program code implementing a web service connector or components of a web service connector. It should be appreciated that alternate embodiments of a GPC may have numerous variations from that described above. For example, customized hardware might also be used and/or particular elements might be implemented in hardware, software (including portable software, such as applets), or both. Further, connection to other computing devices such as network input/output devices may be employed.

It should also be appreciated that the method described herein may be performed by hardware components or may be embodied in sequences of machine-executable instructions, which may be used to cause a machine, such as a GPC or special-purpose processor or logic circuits programmed with the instructions to perform the methods. These machine-executable instructions may be stored on one or more machine readable mediums, such as CD-ROMs or other type of optical disks, ROMs, RAMs, EPROMs, EEPROMs, magnetic or optical cards, flash memory, or other types of machine-readable mediums suitable for storing electronic instructions. Alternatively, the methods may be performed by a combination of hardware and software.

It should also be understood that the software of the invention may be provided to a user through a cloud solution in which the user is able to access and operate the software over the internet. Cloud computing for the delivery of computing services to operate the software may therefore provide greater computing resources in which data storage and computing power may be enhanced. A cloud solution also provides the advantage of not requiring any direct management by the software users and such responsibilities can be handled by professional computer service providers. Accordingly, any reference to the software herein should not be construed to limit the implementation and operation of the software by any particular processing unit, whether the processing unit be located locally or whether the processing is conducted through a cloud solution. Similarly, any reference herein to the computer program product that executes the computer-implemented method or reference to the computer implemented method itself shall not be construed to limit the product or method regarding the particular location of the supporting computer or network components required to deliver the software to the user. The components may be local to the user, remote within a computer network, or remote within a cloud solution, or combinations of any of these configurations.

The term “software” shall be broadly interpreted to include all information processed by a computer processor, a microcontroller, or processed by related computer executed programs communicating with the software. Software therefore includes computer programs, libraries, and related non-executable data, such as online documentation or digital media. Executable code makes up definable parts of the software and is embodied in machine language instructions readable by a corresponding data processor such as a central processing unit of the computer. The software may be written in any known programming language in which a selected programming language is translated to machine language by a compile, interpreter or assembler element of the associated computer. The term “software” shall also include any computer implementations that could be considered as including functionality related to “artificial intelligence”.

Considering the foregoing, in connection with at least one embodiment of the invention, it may be considered a software program or software platform with computer coded instructions that enable execution of the functionality associated with creating the visual displays on the user interfaces described herein. More specifically, the invention may be considered a software program or software platform that executes programmed instructions based on data inputs as described herein.

In connection with yet another embodiment of the invention, it may be considered various sub-combinations including one or more user interfaces generated by the software.

The use of the word “home” or “homeowner” is to be used interchangeably with the corresponding words “building” or “building owner” to confirm that while a preferred embodiment of the invention may be described with respect to a home, the invention is not limited to just homes and the invention therefore is applicable also to computer software and computer implemented methods for any type of building. The use of the word “building” is to be broadly interpreted to include any man-made structure that has an interior and exterior with features that can be selectively designed according to the methods and computer program products of the invention.

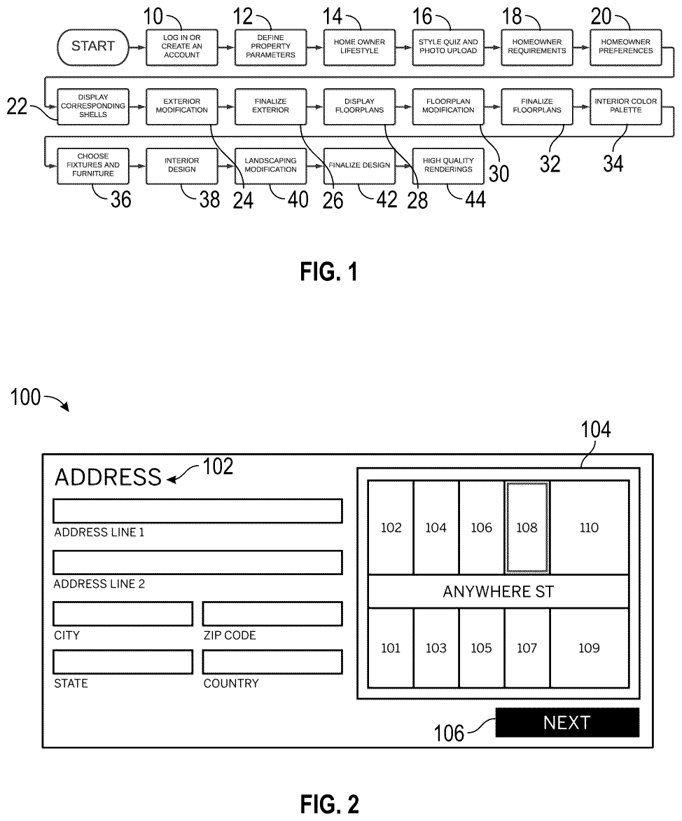

Now referring to FIG. 1, a comprehensive flow chart is provided that details various steps in the execution of a design process for a user to design a custom building such as a home. A first step in the flow chart shows that the user may create and log into an account 10. The next step is to define property parameters 12 which is the particular lot and location where the building is to be built. Defining property parameters may be those which limit options for the user in terms of cost, size of the building, and other constraints. The user may then select homeowner lifestyles 14 which provide certain options for the basic design of the building to include interior and exterior features. The user is then directed to a style quiz 16 in which the user may select assorted styles of buildings, or the user may provide their own photo of a particular style of a building that is desired to be designed and built. Other steps in the method include homeowner requirements and preferences 18 and 20. These steps relate to the options that limit the options of the user in terms of cost, size of the building, and other factors Another step in the method is to display basic shells or overviews 22 of the proposed building with two-dimensional and/or three-dimensional displays of interior and exterior features. Another step in the method is to view and confirm exterior features in which the user may make incremental modifications 24. Another step in the method is to finalize exterior plan 26 in which the user may have modified exterior features in a series of selections. Another step in the method is to display one or more possible floor plans 28. As with the exterior features, the user may modify a selected floor plan 30 and finalize the same 32 in which the selected floor plan is provided in at least a standard two-dimensional floor plan drawing. Additional steps in the method include the user selecting an interior color palette 34 and plumbing fixtures 36 in which a group of colors and fixtures are selected from options viewed by the user in various user screens. Another step in the method is to display interior design options 38 in which the user may select and modify the interior design of the building. Another step in the method is the selection of a landscaping plan 40 in which various landscaping options are provided and again, the user may modify the selected landscaping option. At this point, the user may then finalize the design 42 and view both two and three-dimensional images or renderings 44 of the interior and exterior of the building, landscaping, and interior design features including the selective color palette and plumbing fixtures.

FIG. 2 shows a user interface 100 for selecting the particular property location which includes the property address 102 and the construction area 104, such as lots that have been laid out within a developer's approved development plan. The address information is entered, and the particular lot number is highlighted (108). The address information also enables the software to automatically access the applicable local building codes to get specific information on construction parameters such as the required set back, height and size requirements, and any applicable neighborhood covenants. This information is later used when the software is displaying floor plan shells and possible building layouts. Exemplary information that can be transmitted from this user interface for use with other user interfaces presented to the user include property size, building area height restrictions, property topography, and any other necessary zoning or style parameters. A navigation button 106 labeled as NEXT allows the user to navigate to the next user screen.

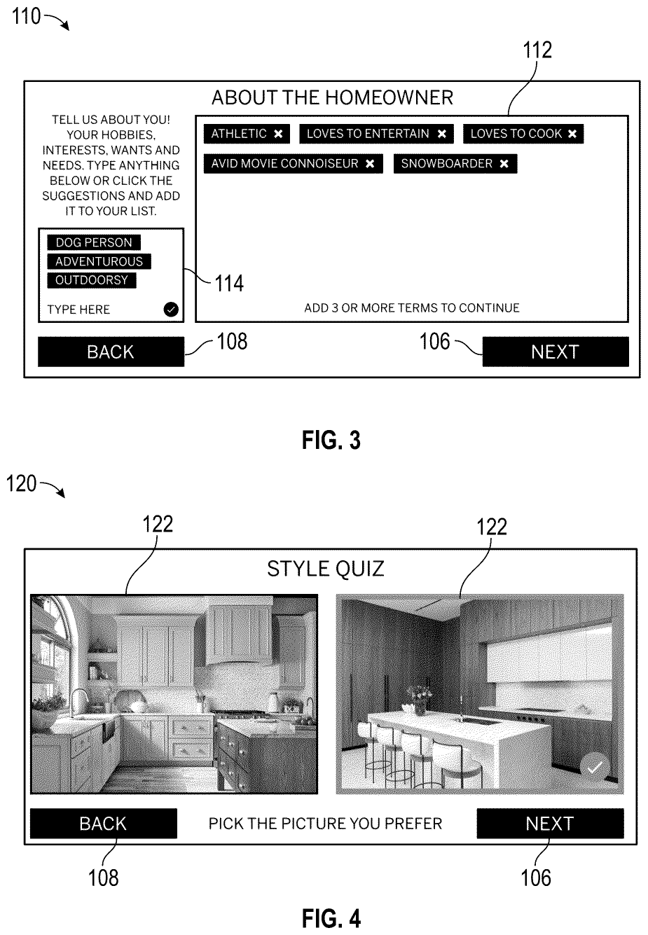

FIG. 3 shows a user interface 110 that is used to obtain information about the homeowner/user such as hobbies or interests shown in window 112. As explained below, these hobbies and interests will be used later in the design process to facilitate options for the user to select interior, exterior, or other features that are advantageous to a person with specific interests. For example, the particular homeowner has indicated that there are five hobbies or interests. Three additional hobbies or interests are added by the user to the existing list of five by the user typing in the three additional interests in the window 114. The “loves to cook” interest/hobby could for example trigger a kitchen design that was very open with a relatively large center island that may facilitate cooking. Information that can be transmitted from this user interface for use with other interfaces could include the identified user's interests/hobbies that are converted to tangible design features such as the kitchen design example. The transmitted information may also be used to modify style quiz to better focus photos with the user's interests/hobbies. FIG. 3 also shows another navigation button, namely, button 108 labeled as BACK that also the user to go back to any prior user interface to view and revise previous selections made by the user.

FIG. 4 shows a user interface or screenshot 120 identified as a style quiz in which the user is able to select a style for an interior room of the building. As shown, the user is presented with two photos 122 of kitchen designs, and the user is instructed on the user interface to select one particular design of interest. One of the photos could be considered a traditional kitchen (left side photo), while the other photo shows a more modern kitchen (right side photo). As indicated by the highlighted photo and check mark, the user has selected the right-side photo.

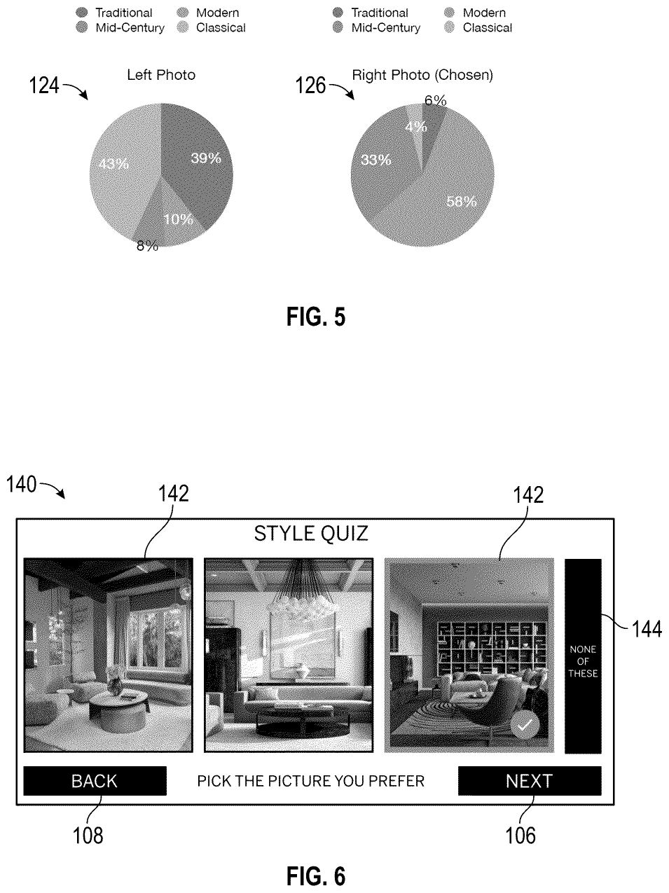

FIG. 5 shows two pie charts 124 and 126 in which the two photos of FIG. 4 have been previously ranked or apportioned in terms of what the photos represent. As shown, the left photo 124 has a greater percentage of classical and traditional aspects and a much smaller percentage of mid-century and modern aspects. Contrast the left photo 124 with the right photo 126 in which the right photo has modern and mid-century aspects with a much greater percentage as compared to the traditional and classical aspects. These apportioned aspects correspond to logic within the software that will later assign specific design features that the user can select for the final designs of both the interior and exterior of the building, as well as landscaping. The user can also be presented with comparative photos for any interior room of the building as well as presented with comparative photos of exterior designs and landscapes. From each of these comparative user screens, the selected photos will also have associated logic that apportions the photos within predetermined design categories. In summary, the apportioned aspects are used to automatically generate features of the overall building design thereby facilitating an incremental and selectable design protocol that is visually presented to the user. The visual presentations made available to the user also allow the user to incrementally update and change many design categories that otherwise would not be able to be seen by the user without the user conducting his/her own research. The illustrated pie charts can be provided to the user in a user interface so that the user can understand how their style quiz answers have resulted in the corresponding percentages of the assorted styles. In some cases, the user may not wish to analyze their quiz results as they are then classified in the pie charts, but nonetheless, the pie charts illustrate that the software incorporates some logic in determining what to visually present to the user, and the logic includes an analysis of various styles. The analysis of the styles ultimately results in images from the style database that are presented to the user.

FIG. 6 is a sample user interface or screenshot 140 that provides another example of a style quiz for another room or area of the building, illustrated as three options 142 for a living room. If none of the options is acceptable, the user may select the “NONE OF THESE” button 144 and the software may generate additional options for the user.

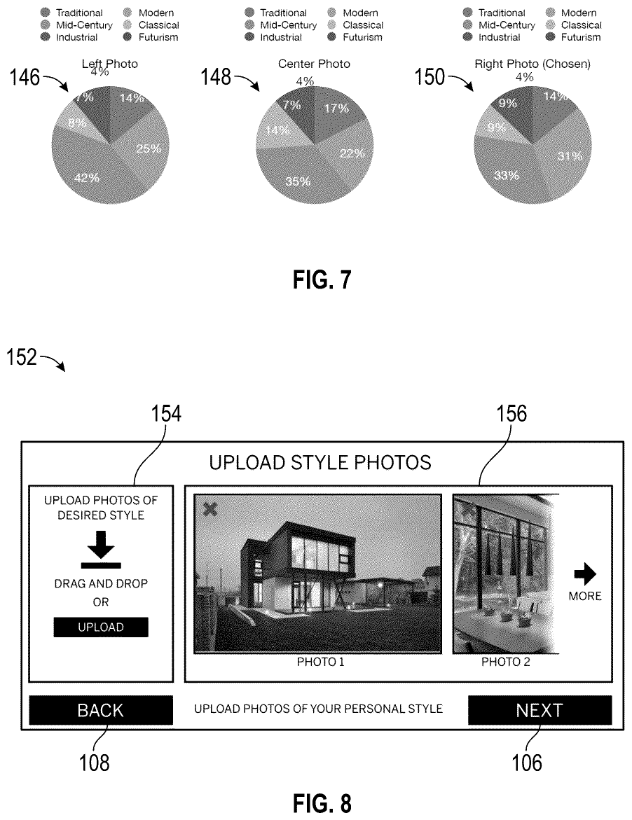

FIG. 7 shows three pie charts 146, 148 and 150 in which the three photos of FIG. 8 have been ranked or apportioned in terms of what the photos represent for styles or features of the living room. Again, these apportioned features correspond to logic within the software that will later assign specific design features that the user can select for the final interior design of the living room.

The style quiz can be repeated for each room of the building as well as the exterior of the building and the landscaping. One or more options are provided to the user in which the user may select one of the options or decline the presented options by clicking on a “NONE OF THESE” button or some other navigational tool on the user interface that directs the user to another option. Once the style quiz is completed, the logic of the software then compiles an ordered set of images for subsequent presentation to the user for the final design.

Referring to FIG. 8, another user interface or screenshot 152 is shown in which after the user has completed the style quiz with respect to selecting comparative photos for the interior rooms, exterior, and landscaping, the user is presented the option for using their own design or style in the event the preconfigured styles shown in the comparative photos do not satisfy the user's design preferences. More specifically, FIG. 8 shows a user interface in which the user can upload photos shown in window 156, such as photos for an exterior design (See e.g. Photo 1) or other photos such as an interior design (See e.g. Photo 2). This user interface shows a window 154 in which user is instructed to drag and drop a photo from a document into the user screen or the user can upload a photo and have it saved in another screen within the software (not shown) and then moved to be shown in the user interface.

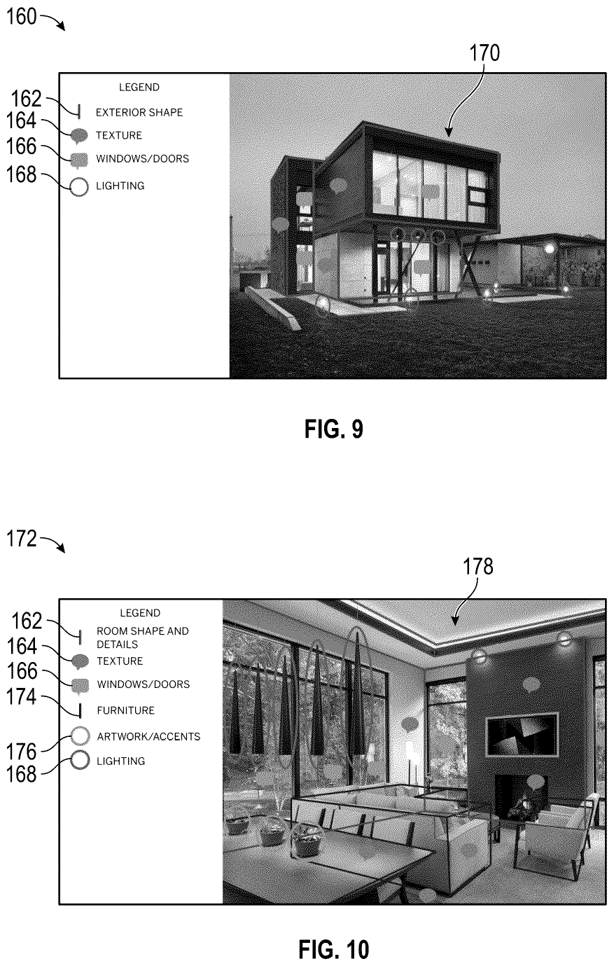

Once a desired photo(s) appears on the user interface, the software has photo recognition capabilities in which the software can process the uploaded photos to define exterior boundaries of the design, and the software may also recognize and define specific features shown in an uploaded photo, as shown in the user interface 160 of FIG. 9.

FIG. 9 is not intended to be seen by the user, but rather, this user interface is intended to demonstrate how the software is able to process uploaded photos. In the example, the software first makes a determination whether the uploaded photo is an exterior or an interior photo. FIG. 9 illustrates an exterior and the software will automatically draw or create an outline over the exterior silhouette of the building to include delineating structural separations such as different floors or definable modules of the home. This is shown in FIG. 9 with the exterior shape lines 162. The software will also automatically identify specific features of the silhouette to include textures 164, the location of windows and doors 166, and lighting 168 as shown. The dimensions and features as identified by the software are later used in various calculations to thereby provide the user with appropriate design selections comments such as colors for the exterior of the home, the floor plans of the home and other parameters. It is contemplated that within a style database of the software, there are a substantial number of exterior designs, interior designs and other components of homes that can be used to match and present to the user recommended styles that are matched with the uploaded photos. In other words, the uploaded photos from the user are matched within the style database to thereby provide the user with the best matches for home styles. Additionally, the software separates landscaping from the photo with the structure of the home so that the user can independently select a desired landscaping. Further, the software analyzes how much from the uploaded photo matches elements within the style database, such as by cross referencing shapes, colors, and proportions in order to provide a best match. With respect to the aforementioned pie charts, percentage apportionment of different styles or features can also be derived based upon the percentage of similarities with the uploaded photo.

The user interface of FIG. 9 can be viewed by, for example, an administrator of the software and the features identified in the photo should closely match the actual photo. If there appear to be errors in the photo recognition, the administrator can selectively move exterior shape lines by placing a cursor over the misaligned shape line, clicking on the shape line and then dragging or rotating the shape line to its properly aligned position. Similarly, if there are windows or doors that are misaligned, the administrator can click on the window or door at issue and then rotate and/or drag the window or door to its aligned position with the photograph With respect to texture and lighting, the administrator can also move, add, or delete these features. It therefore should be apparent that the software of the present invention is capable of using uploaded photographs to subsequently incorporate them into a desired building design. Ultimately, an uploaded photo is transformed into a virtual image that is stored in the style database and then becomes a usable image that can be selected by the user during the user's selection process for a building design.

FIG. 10 shows another photo recognition user interface 172 with respect to a photographed and uploaded photo of an interior room. Similar to the recognition capability in FIG. 9, the software is able to identify and incorporate each item illustrated in the uploaded photo for creating an interior design template. As shown, the items or features in the interior room that can be incorporated include the room shape and details 162, textures 164, windows and doors 166, furniture 174, artwork and accents 176 and lighting 168. For each of the identified items, the style database of the software also includes a substantial number of data elements that can be matched with the photographed items. For example, the couch illustrated in FIG. 10 can be closely matched to a couch within the existing style database or can be matched with cross reference to a catalog image that is subsequently imported to the style database from the catalog. The couch image imported from the catalog is made available for display to the user during furniture selection. In the same way, the other identified features in FIG. 10 can be matched by the software either by existing data elements in the style database, or by import from another image, such as texture and lighting found in online catalogs.

According to one embodiment of the invention, before the software references an imported photo with the photos from the style database, the software first recognizes whether the photo is an interior or exterior photo. After the software confirms what is shown in the photo, e.g. an interior room, the software matches the room type (such as bedroom, kitchen etc.). According to one matching logic feature of the software, an uploaded photo may closely match one or more existing images of interior rooms that exist in the style database. If no existing image in the database is found to match, the uploaded photo, after being recreated as a virtual image, can be saved as a new data element image in the style database and subsequently accessible as a new interior room image. With respect to more than one potentially matching existing image in the style database, the software automatically references various features of the uploaded photograph as compared to the existing images in the style database. These features can include the shape of the interior room, color patterns, general proportions with respect to furniture and spatial configurations of the interior room. Each of the potentially matching existing images in the style database are ranked with the image having the greatest number or percentage of similarities with the photo to be selected as the first image displayed to the user. In the event there are many existing images that are very similar and almost indistinguishable in terms of how they match the uploaded photo, each of these images may be presented to the user for subsequent selection. With respect to the exterior of a building in an uploaded photo as well as landscaping, the software will automatically search the existing style database for the one or more images that most closely match the features identified in the uploaded photo. Each potentially matching image is then ranked in terms of how closely it matches the uploaded photo. Again, one or more of the images from the style database may subsequently be presented to the user so the user can then decide whether to choose a particular presented exterior design or landscaping. The associated logic of the software program, in terms of identifying potentially matching images from the style database or making a decision to create a new image in the style database that better matches the uploaded photo, can rank order images for presentation to the user on a percentage basis in which each identified feature of the photo should correspond to a similar feature in an image of the style database. Another manner in which rank ordering can be achieved is by weighted elements in which certain identified elements in the photo have a greater weight than other identified features. For example, with respect to an exterior design, it could be determined that the basic shape or outline of the building in the uploaded photo should be given greater weight than the lighting or the color patterns incorporated in the photo. Regardless of the exact logic associated with matching images from the style database with an uploaded photo, it should be apparent that this automatic feature of the invention provides a great user-friendly feature in which a user is not forced to select only from a limited number of designs within the style database.

For both interior and exterior photo recognition, the software of the invention may have one or more databases of component images for lighting, furniture, artwork and accents, and other exterior and interior elements. The software will again use these component images to closely match the uploaded style photo. For example, if a lighting fixture arranged to shine light on an adjacent wall at an angle of 30° in an uploaded photo, the software will take into account the position of the light with respect to the wall and also the angle of emission so that the image presented to the user for design selection has these fine details.

After the style quiz and uploaded style pages have been completed, and the software makes a determination that the user's personal style results are complete, these results are added into the user's profile to be used later in design questions.

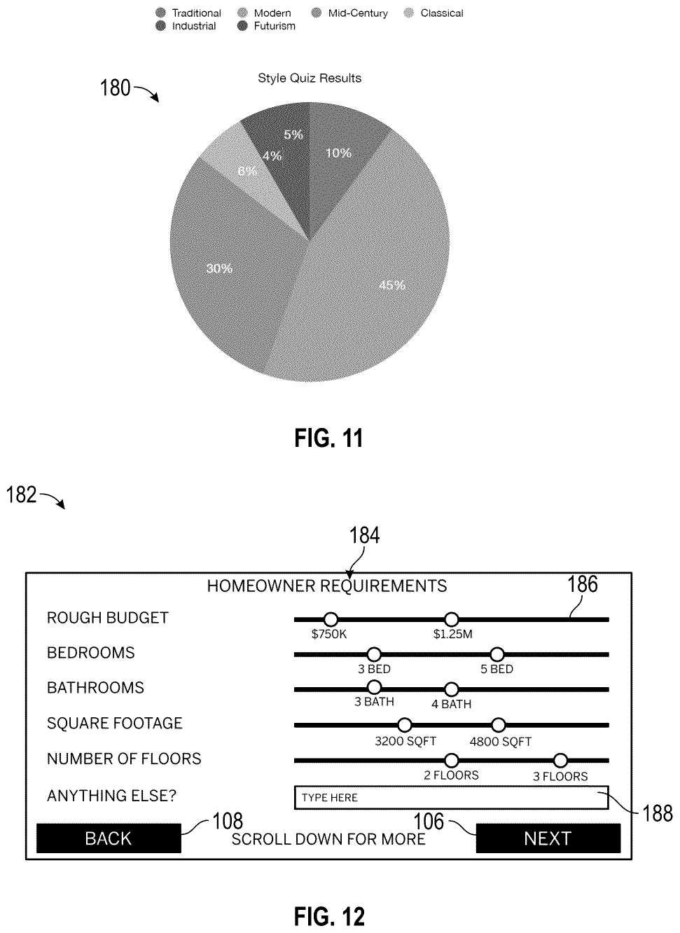

In this regard, reference is made to the pie chart of FIG. 11 that displays example results of a style quiz. The results are shown in the pie chart 180. Specifically, this user interface indicates that two styles were dominant, namely, the modern style and the mid-century style in which collectively these two styles make up 75% of the whole.

FIG. 12 shows another user interface 182 that is used to gather information regarding a homeowner's general parameters or limits regarding a home to be built. As shown, this user interface has five parameters 184 that the user can select on corresponding sliding scales 186. The first parameter is a rough budget where the homeowner selects a general range for the price to design and build the home. The first parameter is shown as a range between 750,000 dollars and 1.25 million dollars. The second parameter shown is the number of bedrooms and the user selected between 3:00 and 5:00 bedrooms. The next parameter is square footage and the user selected between 3200 square feet and 4800 square feet. The next parameter shown is the number of floors and the user selected two or three floors. The user interface also includes a parameter that can be entered by the user in the Anything Else block 188. For this parameter, the software may contain other typical home parameters that can be matched with what the user has entered in which case another user interface could show the sliding scale for that user entered parameter. The information that is computed and processed from this user interface includes any of the information selected by the user.

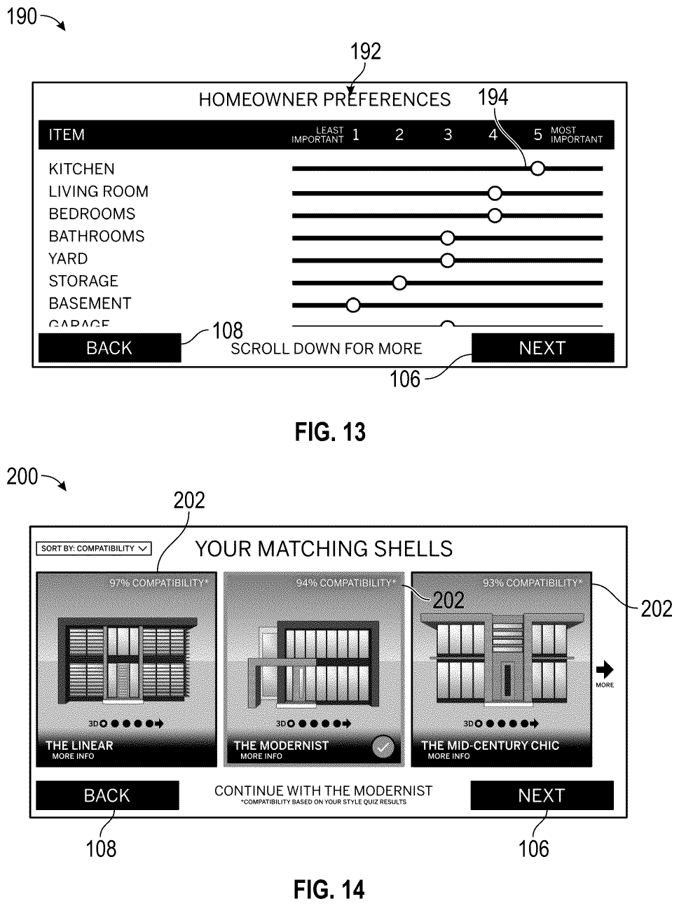

FIG. 13 shows another user interface 190 that is used to determine the homeowner's priorities or preferences 192 regarding the design of the building. The priorities are again shown on a sliding scale 194 from 1 to 5, in which one is the least important and five is the most important. A listing of rooms or features of the building and landscaping may be presented on this user interface and the user then ranks the importance of each feature. In the example of this figure, the kitchen was rated as most important while the basement was rated as least important. The homeowner's priorities are used to enable design of the building in which case if any sacrifices are to be made in the design, the software attempts to 1st make sacrifices with respect to the least important rooms or features as selected on this user interface. The term “sacrifices” is intended to convey a situation in which a user has made selections regarding, for example, floor plans and if the floor plans need to be adjusted to fit within one of the homeowners general parameters, then changes or sacrifices are made first with respect to the least important homeowner preferences.

FIG. 14 shows a user interface 200 for a group of three shells 202 that have been selected for the user to view based upon the previously entered data regarding the style quiz, any uploaded photos, property parameters, local building codes, and homeowner preferences and homeowner lifestyle questionnaire. Each of the shells has an image that is displayed as a general cover image to convey a basic design of each shell. It should be understood that each shell presented in the user interface can be completely unique for each homeowner using parametric elements as discussed below. The user can specify sorting of the shells for presentation on this user interface based on the user's previous inputs including the style quiz, uploaded photos, and other selected design features. As shown specifically in this figure, three matching shells are illustrated along with the percent compatibility score. The user in this example has selected the “Modernist” shell as indicated with the check mark. Although the “Linear” shell has a slightly higher compatibility percentage, the user nonetheless has selected the “Modernist” shell. Therefore, it should be understood that the percent compatibility scores will not necessarily dictate what the user may wish to incorporate within the final design. Nonetheless, the compatibility percentages should provide some indication to the user that their previous preferences as compiled from the style quizzes resulted in the images shown on the user interface for the respective shells.

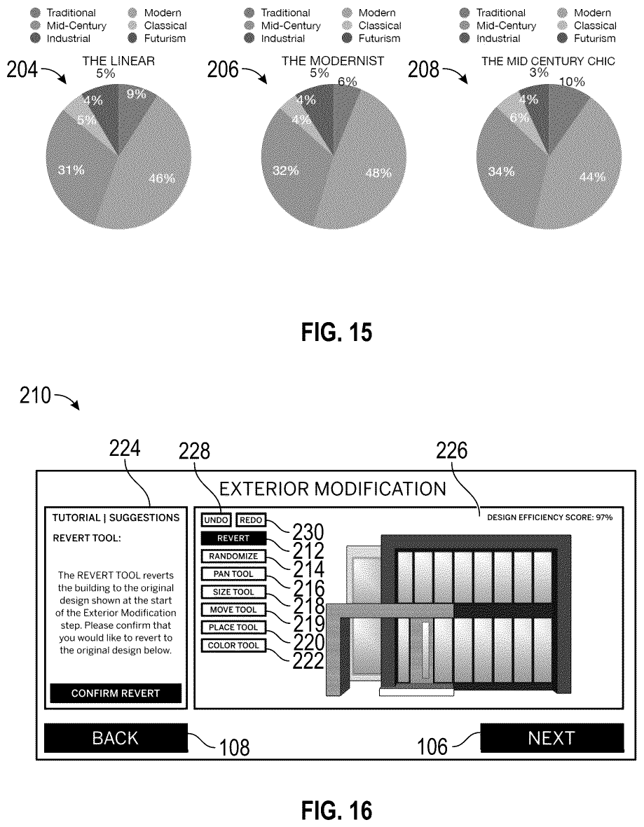

FIG. 15 shows representative pie charts that indicate the compatibility of matched types of styles with user's preferences obtained from the style quiz. More specifically, FIG. 15 shows pie charts 204, 206, and 208 in which the respective proportions of the shells are broken down or apportioned according to their styles. As shown, the user has selected the matching Modernist shell that has a 94% compatibility score. The other two shells illustrated are the Linear shell and the Mid-Century Chic shell.

FIG. 16 illustrates a user interface 210 that allows for exterior modification of the building. The user interface specifically shows a number of tools that can be selected by the user in order to revise and finalize the exterior. The Revert Tool 212 is shown as being selected in window 226 which automatically results in the window 224 being presented that explains the function of the Revert Tool. As shown in the window 224, the Revert Tool, if selected allows the user to go back or revert the building to the original design at the beginning of the exterior modification step. If the user would like to revert, the user then clicks on the confirm revert button. Also illustrated is the design efficiency score which is an arithmetic calculation that confirms how efficient the design is as it is presently illustrated in the user interface.

The manner in which the user changes or modifies the illustrated exterior is by clicking on the structural element of interest and once highlighted, the user can select to modify that structural element in accordance with one of the tools in the menu of tools. The undo button 228 allows the user to undo the most recent change or modification that the user may have selected at that incremental modification step. The redo button 230 allows the user to redo the most recent change or modification that the user may have selected at that incremental modification step. If the design efficiency score drops below a predetermined percentage, one or more suggestions will automatically be generated as a pop-up window (not shown) on the user interface to improve the design efficiency score. As mentioned, the user may also select the Revert Tool to go back to the originally shown pre-generated exterior design.

The design efficiency score is displayed in the corner of the editing tools when editing the interior or exterior of the building. The design efficiency score takes into account numerous variables, such as people flow efficiency throughout the building as a function of how people walk through the building, efficiency of layouts, natural lighting provided from windows and doors, efficiency of furniture and fixture placement, size of rooms, hallways, and elements. For example, if the user is designing a kitchen space, and the user chooses to move the sink farther away from the main cooking area, thereby making the kitchen less efficient, the software will then lower the design efficiency score because of the movement of the sink. As another example, if the user modifies the layout of the master bedroom, making the master bathroom smaller and with fewer fixtures, this will also reduce the efficiency of the design because the modification makes the master bedroom more difficult to walk through or otherwise occupy. If the design efficiency score drops below a predetermined level or percentage, the software will prompt the user to make changes and suggestions will be shown on a user interface as to how to increase the efficiency of the space.

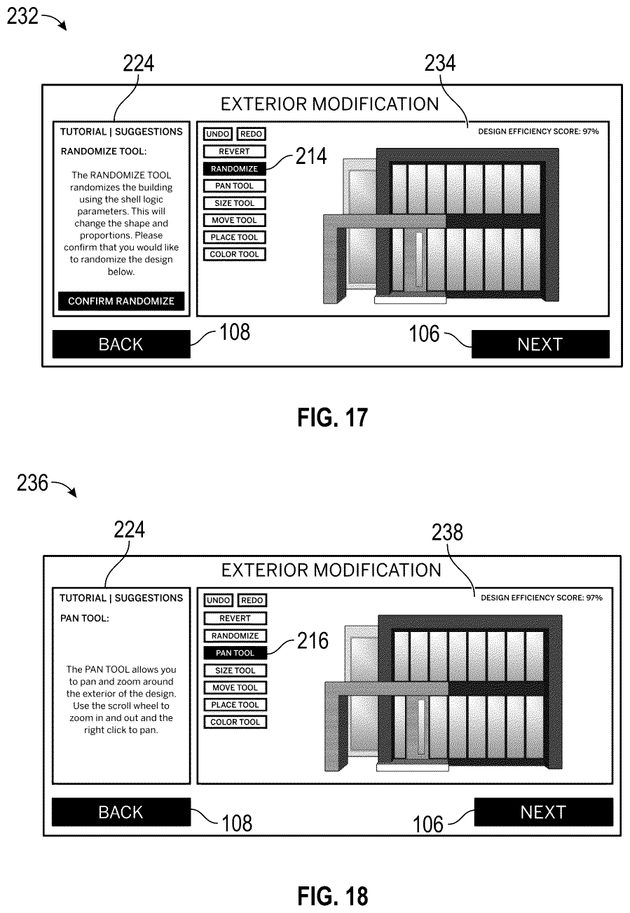

FIG. 17 illustrates a user interface 232 where the user has selected the Randomize Tool 214 in window 234. This tool uses shell logic parameters for the chosen shell and parameters that have been entered by the user in the previous steps to change the size, proportions, and location of each attribute or feature. If the user does not like the desired effect of the Randomize Tool, the user can select the undo or Revert Tool.

FIG. 18 illustrates a user interface 236 where the user has selected the Pan Tool 216 in window 238. As shown in the tutorial window 224, the Pan Tool allows the user to pan or move and zoom around the exterior of the design. The user may operate the scroll wheel to zoom in and out of the depicted design. Accordingly, the exterior modification user interface 236 can also be illustrated three-dimensionally in which as the user operates the scroll wheel of a computer mouse, the user can not only view the front of the exterior, but also the sides, rear, and top of the exterior. Accordingly, while user interface 236 illustrates a two-dimensional image of an exterior, a three-dimensional exterior could be illustrated.

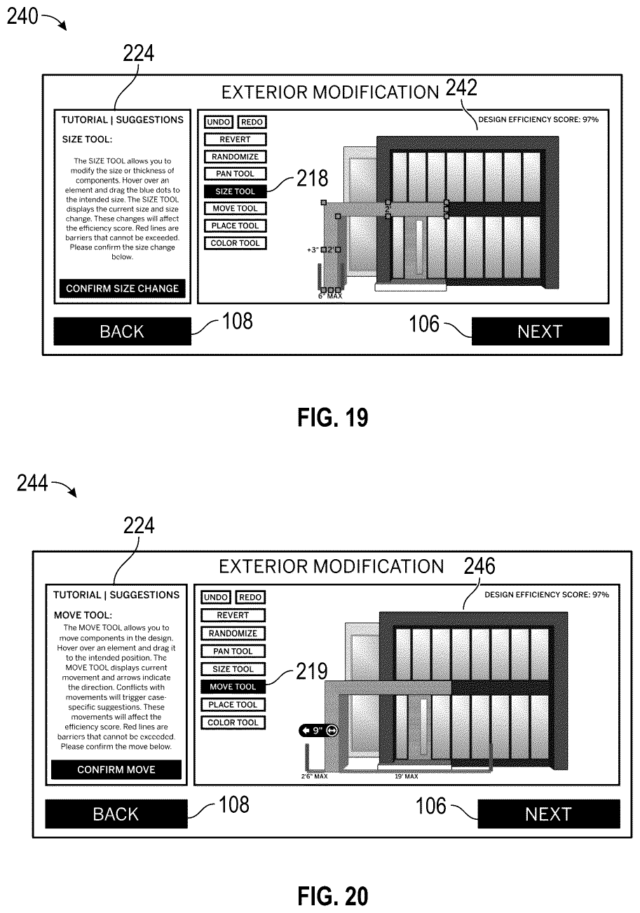

FIG. 19 illustrates a user interface 240 where the user has selected the Size Tool 218 in window 242. As shown in the tutorial window 224, the Size Tool enables a user to change the size of an object or attribute. In the example illustrated, the user is increasing the thickness of attribute number one shown in green color. The red barrier is a visual element that provides the maximum amount of movement that the object can be moved, either laterally or vertically, without exceeding design parameters. Beneath the red barrier is an indication of how far the object can be moved and, in this example, there is only a 6-inch variation available. The blue dots are used by the user to change the size of the element. If there are multiple sizes in one attribute that match the user will be asked if they want to have both sizes increase or decrease. For example, the horizontal portion of this attribute and the leg width of the vertical portion of this attribute are both 2′, the user will be asked if they would like both of those sizes to change and match when they increase or decrease one of the two. Next to the blue dot that has been dragged is an indication of the size change that has occurred, in this example, a plus (+) 3″ Is added to the width.

FIG. 20 illustrates a user interface 244 where the user has selected the Move Tool 219 in window 246. The Move Tool is used to move attributes and objects in the design. To use this tool, the user clicks on an attribute or object that is to be moved, and it then becomes highlighted in green. Each attribute and object are case specific and will display the max movement in either direction with red barriers. After the selected object or attribute has been moved, it will show the movement change and movement direction. If there is a conflict for a move, case-specific suggestions will be triggered to overcome this conflict to thereby increase the design efficiency score. Any time that an attribute is moved, matching or locked objects, or attributes, will be moved or changed based on a single move. For example, if the user has moved the left-hand portion of attribute 1, and locked objects, such as house numbers will then also be moved with the user's input. Additionally, the lighting below this attribute will be changed to match the user's movement.

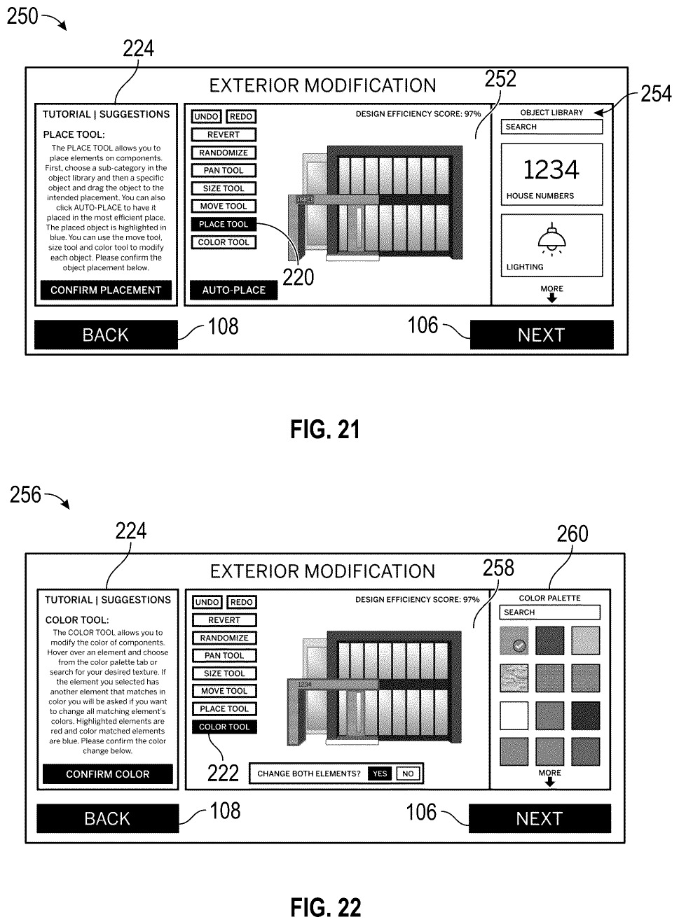

FIG. 21 illustrates a user interface 250 where the user has selected the Place Tool 220 in window 252. The Place Tool is used to place additional objects in the design. An object library 254 is shown on the right of the user interface and includes subcategories of objects such as house numbers, lighting, and accents. When a user clicks on a subcategory, such as house numbers, the user will be shown multiple versions of that subcategory to choose from. Additionally, the user can search for objects within the depicted search tab. After choosing an object, the user can drag an image of the object into the design shown on the user interface, and the software will display the areas where that object can be placed which will be highlighted in green. The user may also select the Auto-place option in the window 252, which results in the software automatically placing the object in the most efficient position. A most efficient position can be predetermined by the software in which factors such as eliminating additional design costs may dictate the result of the user selecting the auto place option. After the object has been placed, the user can use the Size Tool, Move Tool, and Color Tool to modify or move the object. The most recently placed object is highlighted in blue, and after the desired placement has been achieved, the user will confirm the placement, such as by double clicking on the object.

FIG. 22 illustrates a user interface 256 where the user has selected the Color Tool 222 in window 258. The Color Tool is used to modify the color of an object or attribute. On the right of the screen is the color palette window 260 in which the user can choose from the textures shown or search for a specific texture using the search tab. If there are two or more matching elements that share the same color in a design, the user will be presented with a pop-up question on the user interface whether the user would like to change the colors of both of those elements. The user will not be asked to change both of those elements if the texture that they have chosen is not valid on both attributes. For example, if the user chooses brick for the attribute shown in the red outline, the user will not be asked to also change the front door shown in the blue outline, Each attribute or object that is clicked on will prompt a separate set of textures in the color palette based on the case-specific colors allowed on that attribute or object.

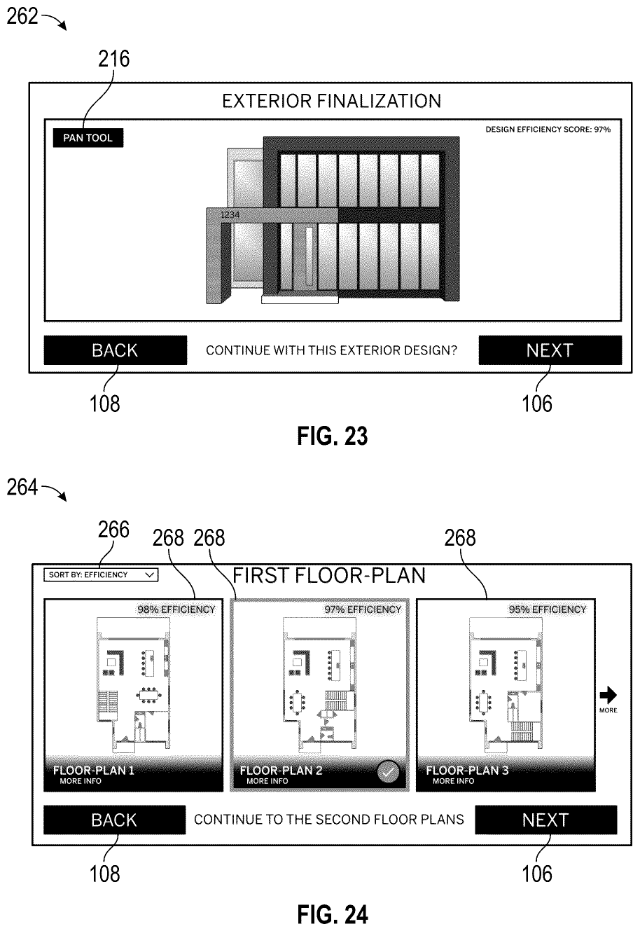

FIG. 23 illustrates a user interface 262 where the user has selected an option to view a final version after the exterior modification has been completed. Only the Pan Tool 216 is used to look over the completed exterior of the building to ensure that it is what the user has desired. The design efficiency score is again shown, and if the design efficiency score is too low, the user will be prompted with suggestions on how to improve the design efficiency score.

FIG. 24 illustrates a user interface 264 with floor plans 268 for the first floor of the building to be constructed. Each floor plan option is shown in a separate window that can be selected for review and editing by the user. The example in this figure shows the user has selected the second option or floor plan 2. A user is required to first review and confirm the first or bottom floor of the building so that the overall footprint of the building can be established. Each of the floor plan options are shown with their corresponding efficiency scores. As mentioned, an efficiency score references numerous variables, such as coherence and flow throughout the design, stairway placement, and room efficiency among other variables. In the event the user wants to sort the available floor plans of a floor by efficiency, the user can select the Sort By option shown in window 266. If selected, this option allows the user to sort by lowest to highest efficiency, highest to lowest efficiency, or other parameters,

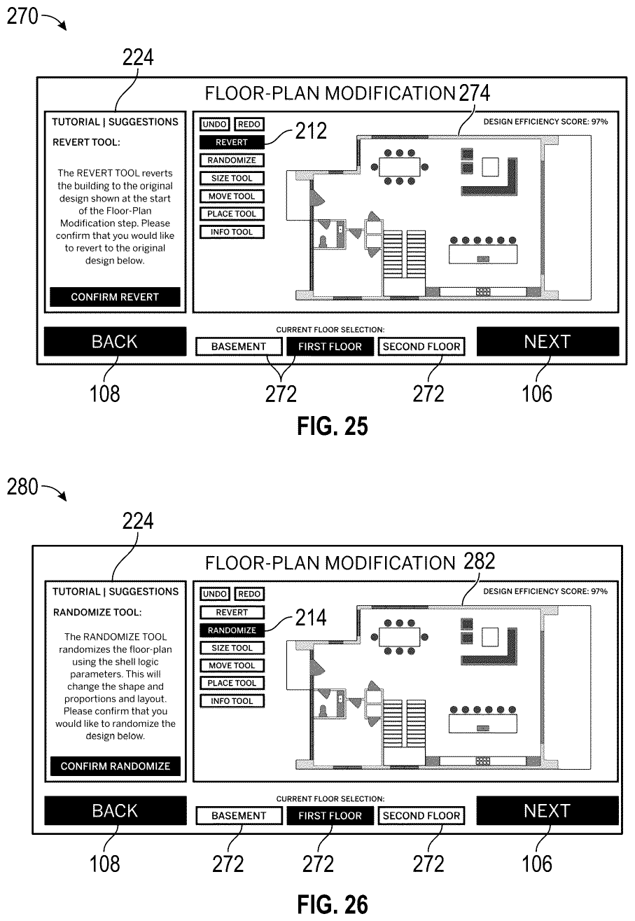

FIG. 25 illustrates a user interface 270 for the floor-plan modification step that begins with the main floor of the building so that multiple floor elements such as stairs can be set before moving on to subsequent floors. The floor selections available are shown at options 272 with the first floor being selected by the user. The other options available to the user shown in this figure include the basement and the second floor. This figure also shows that the user has selected the Revert Tool 212 that has the same functionality as previously described. The design efficiency score is shown as well. The first-floor floorplan 274 is shown with traditional floor plan symbols illustrating walls, interior rooms, a staircase and optional furniture pieces. Specifically, the floor plan shows an interior room on the left side of the plan, a bathroom, two closets, a table with eight seats or chairs, a serving bar or kitchen island with six seats, an L-shaped couch or sofa, two living room chairs and a square shaped coffee table. HAVE COLE CONFIRM OTHER FEATURES SHOWN

FIG. 26 illustrates a user interface 280 for the floor-plan modification of the depicted floor plan 282 in which the user selected the Randomize Tool 214. Like the Randomize Tool for the exterior design, this Randomize Tool uses shell logic parameters for the chosen shell and parameters that have been entered by the user in the previous steps to change the size, proportions, object placement, and layout. If the user does not like the desired effect, the user can select the undo or Revert Tool. The first-floor floorplan 282 in this figure is the same as the first-floor floorplan shown in FIG. 25 because the user has yet to make modifications or changes to the floor plan.

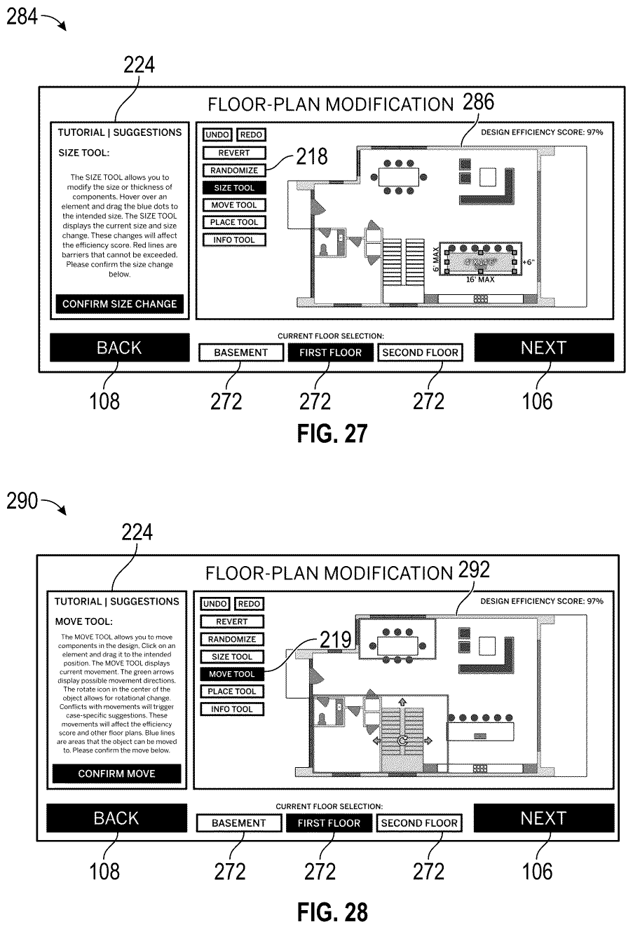

FIG. 27 illustrates a user interface 284 for the floor-plan modification of the depicted floor plan 286 in which the user selected the Size Tool 218 in order to change the size of an object or attribute. NOTE HAVE KUMAR CORRECT THE PLACEMENT OF THE LEAD LINE TO POINT TO THE SIZE TOOL In the shown example, the user is increasing the size of the kitchen island. The red rectangular shaped barrier cannot be exceeded. Below the red barrier is the max length movement number (shown as 16 feet) and the maximum width movement number is 6 feet. The original dimensions of the kitchen island are shown within the green area of the kitchen island (4 feet by 14 feet). The blue dots are used by the user to change the size of the element by dragging the dots to the desired size for the kitchen island. Next to the blue dot that has been dragged on the right side of the barrier is a figure on the size change that has occurred (a 6-inch increase in the kitchen island length). With the size tool 218, it should be apparent that the user is able to independently modify the location of elements within the floor plan so long as the modifications do not extend beyond the bounds of the respective barriers. The size of the barriers and whether there are any specific barriers that must be adhered to within the floor plan are functions of the original parameters or styles that the user may have selected. In the event that the user wishes to modify the scope or number of barriers, another user interface can be presented to the user which allows the user to also modify, add, or delete barriers. In each case, the software will automatically recalculate design efficiency scores as the changes to any barriers are incorporated within the presented floor plans.

FIG. 28 illustrates a user interface 290 for the floor-plan modification of the depicted floor plan 292 in which the user selected the Move Tool 219 in order to move attributes and objects in the depicted floor plan. To use this tool, the user clicks on the attribute or object that is desired to be moved and the selected attribute/object is then becomes highlighted in green. Green arrows show the possible movement direction for the selected attribute/object. Each attribute/object has predetermined areas where the attribute can be moved to, and such areas are shown in blue barriers. In this figure, it is shown that the selected staircase can be moved anywhere within the blue barrier. Although not selected, the figure also illustrates that the eight-chair table could also be moved within its corresponding blue barrier. As the user moves the selected attribute/object the user display shows the moved selected object or attribute. The movement change and movement direction is also shown. If there is a conflict for a move, case-specific suggestions will be triggered to overcome this conflict and increase the design efficiency score s. Any time that an attribute is moved, matching or locked objects, or attributes, will be moved or changed based on a single move.

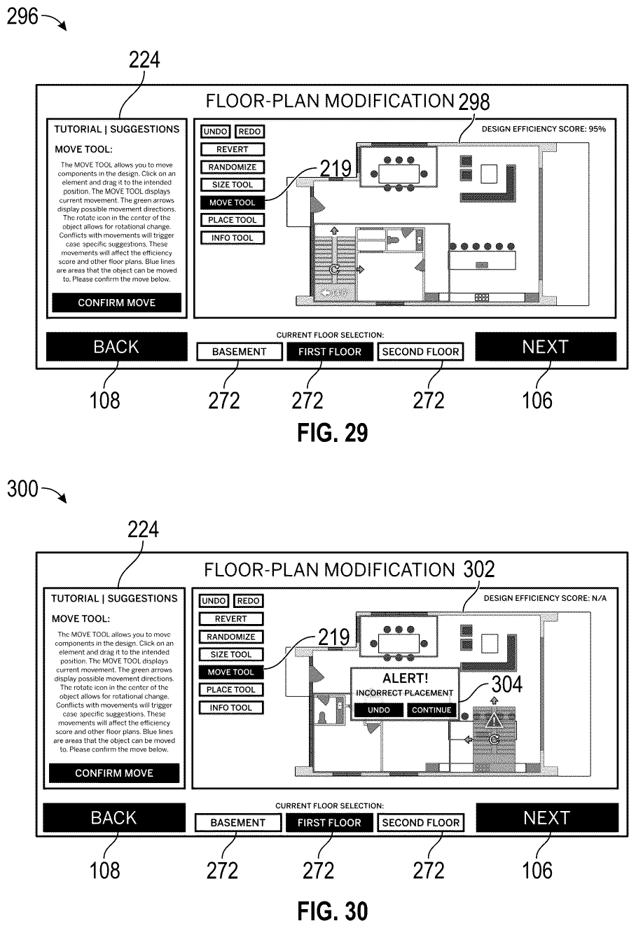

FIG. 29 illustrates a user interface 296 for the floor-plan modification of the depicted floor plan 298 in which the user interface shows what happened when the user moved the stairway over to the left side of floor plan. The white arrow on the object shows the direction of the movement, and next to the arrow is the movement change to the left by 14′6″. When the user moves the stairway, the movement causes the displacement of interior room, so the software automatically re-drew this area using the shell parameters to show the interior room located to the right of the stairway. Moves made by the user may affect other floors and other attributes in the current floor. For example, this stairway move in this figure will obviously affect the second floor and the basement layouts which must be modified to show the moved location of the stairway. Having the user begin floor plan modifications on the main or first floor is the most efficient way to incorporate floor plan modifications because a modification on the main floor such as moving the stairway automatically changes the floor plan of other floors and it is presumed the user wishes to first confirm a first-floor plan.

FIG. 30 illustrates a user interface 300 for the floor-plan modification of the depicted floor plan 302 in which the user attempted to move an attribute, namely the staircase, to an incorrect placement outside of the blue border. As illustrated, a pop-up window appears, and the user must either undo the move or continue the move. Selecting the undo option returns the object to its original location. Selecting the continue option enables the user to reengage the object and further move the object to another position. Anytime an attribute or object is moved to an incorrect or out of bounds placement, the user will be unable to confirm the move and proceed with the design until the movement error is corrected.

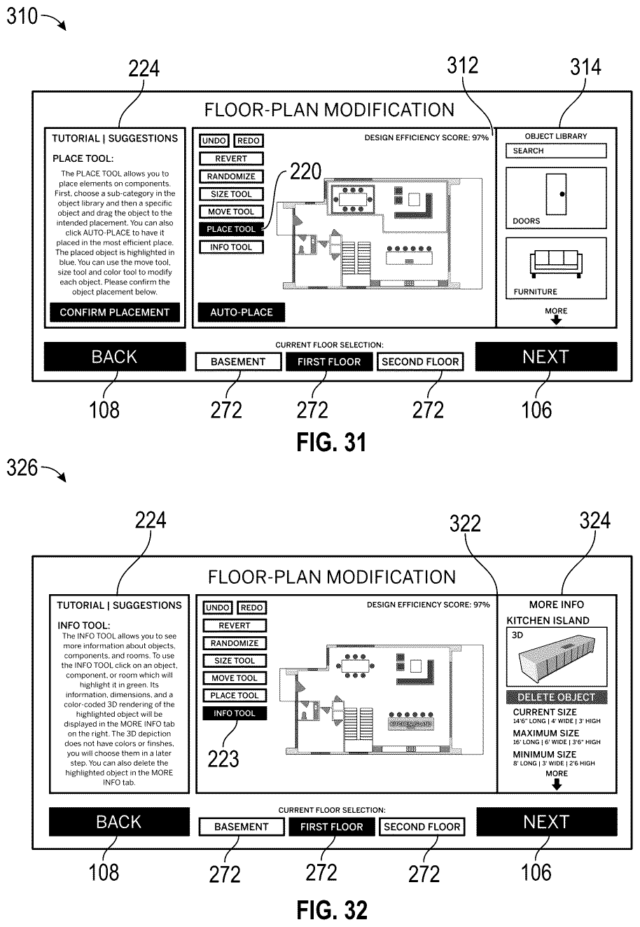

FIG. 31 illustrates a user interface 310 for the floor-plan modification of the depicted floor plan 312 in which the user has selected the Place Tool 220. The Place Tool is used to place objects in the depicted floor plan. An object library 314 is shown in which a user may select various objects to be placed in the floor plan. The object library includes subcategories of objects such as doors, furniture, and accents. When a user clicks on a desired subcategory, such as furniture, the user is then shown multiple versions of that subcategory that the user can choose from. The user may also search for other subcategories of objects within the depicted search tab. After choosing an object, the user drags the object into the floor plan. The software will automatically designate which areas that the object can be placed in. The designated area in this figure is shown in the green highlight. The user may also click on the Auto-place option that will automatically place the object in the most efficient position. After the object has been placed, the user can optionally use the Size Tool or Move Tool to modify or move the object. The most recently placed object is highlighted in blue, and after the desired placement has been achieved, the user will confirm the desired placement of the object, such as by double clicking on the object. It is noted the objects placed in the floor plan modification step are shown in two dimensions however, specific textures and other attributes of the objects can be selected in later user interfaces as discussed below. If an object is added in an area where another object is originally located, the other object is automatically moved to another location in the floor plan and the user can also then move the other object to a suitable location by again using the Move Tool.

FIG. 32 illustrates a user interface 326 for a floor-plan modification of the depicted floor plan 322 in which the user selected the Info Tool 223 and has also highlighted the kitchen island object. With selection of the Info Tool, the user is shown the current information about the object in the More Information window 324. As shown, the window 324 provides the current size, maximum and minimum size, and other specifications of the object. Additional specifications of the object can be viewed by clicking on the More arrow. By highlighting an object or element, the user can delete the object and then replace it using the Place Tool. The More Information window 324 also shows a three-dimensional image of the object. As should be appreciated, the Info Tool can provide a great amount of detailed information about any specific element or object illustrated in a floor plan and this feature therefore provides the user with great flexibility in terms of modifying illustrated objects within any floor plan.

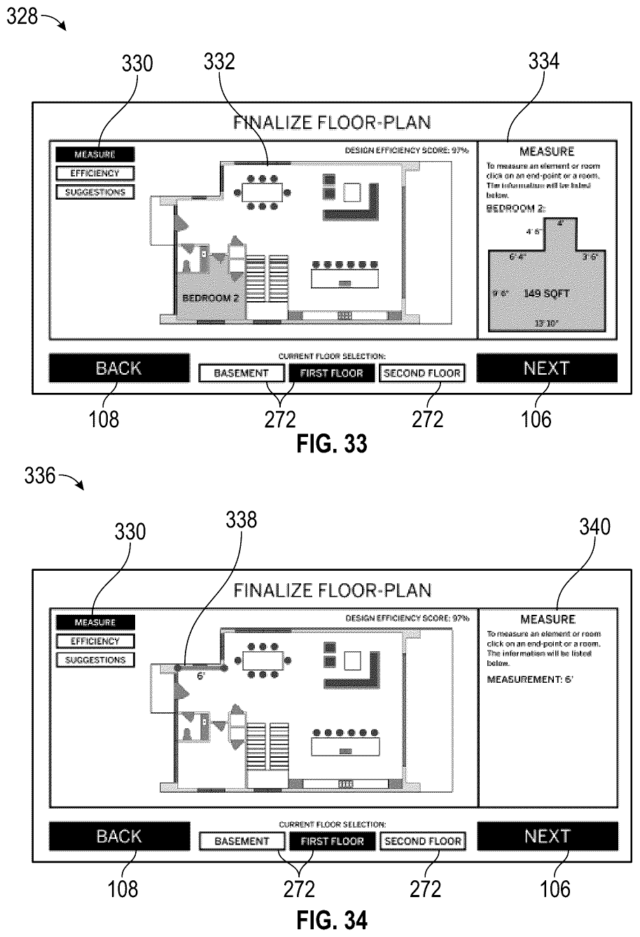

FIG. 33 illustrates a user interface 328 for finalizing a floor plan of the depicted floor plan 332. The user interface for finalizing a floor plan allows the user to review the floor plans for all floors of the building after the user may have modified the floor plans. Any of the floor plans may be accessed from this user interface as shown with the tabs 272. The navigational tabs 108 and 106 may also be used by the user to go back and modify a selected floor plan or to move to the next design step. Three tools are illustrated in the user interface and in this example, the user selected the Measure Tool 330. The Measure Tool as illustrated can be described as a point-to-point tool in which the user can click on end points at any location within the floor plan and then the corresponding measurement will be shown in the Measure Tool window 334. The selected measurement endpoints and corresponding measurements are highlighted in blue in the user interface. The Measure Tool gives the user detailed information on any measurement within the floor plan that may assist the user in further modifying the floor plan or to add or remove existing objects in the floor plan.

FIG. 34 illustrates a user interface 336 for finalizing a floorplan of the depicted floor plan 338 in which the user has selected the Measure Tool 330 for purposes of measuring one specific outer wall segment of the floor plan. As shown, the user selected the blue highlighted wall segment by clicking on both ends of the segment. Within the Measure window 340 is shown the length of the selected wall segment. The user may select any element, object, or segment shown in the floor plan and the software will automatically calculate the length of the measurement.

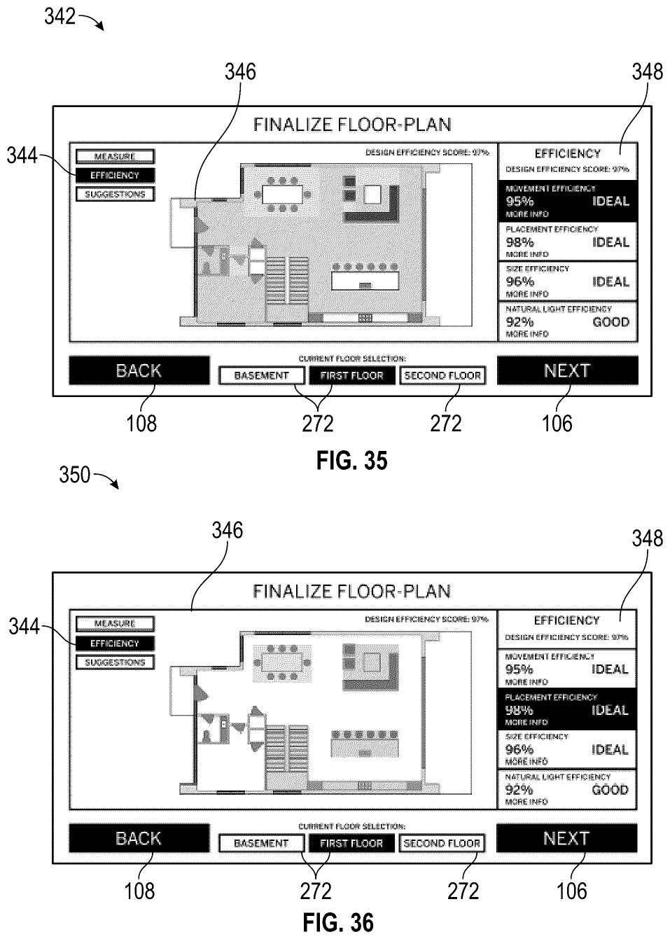

FIG. 35 illustrates a user interface 342 for finalizing a floor plan of the depicted floor plan 346 in which the user has selected the Efficiency Tool 344, and the Movement Efficiency is shown is highlighted. The efficiency tool can be used to identify and measure several types of efficiencies in the floor plans. The efficiency window 348 is shown in which there are four types of efficiencies shown, namely, movement efficiency, placement efficiency, size efficiency, and natural light efficiency. In this figure, the efficiency relates to movement of people within the floor plan in which the higher the efficiency score, the more efficient the floor plan space is rated. The software drives movement efficiencies by, for example, placing virtual people in different areas of the floor plan and then generates route instructions for the virtual people to move to different areas of the floor plan. Efficiencies are ultimately calculated by factors such as how many times people come close to one another in tight spaces. Areas that are more difficult to navigate as opposed to areas that are easier to navigate may be shown in assorted colors. For example, green highlighted areas may indicate areas that are easier to navigate, yellow areas may indicate areas that are more difficult to navigate, and red may indicate areas that are most difficult to navigate.

FIG. 36 illustrates a user interface 350 for finalizing a floor plan of the depicted floor plan 346 in which the user has again selected the Efficiency Tool 348, and the Placement Efficiency is highlighted. The Placement Efficiency of a floor plan shows areas where objects in the floor plan have been placed in the most optimal areas. The objects are highlighted from green being the best to red being the worst. The rating of best to worst takes into account data from the movement efficiency and other data in which optimal object placement may be a predetermined parameter.

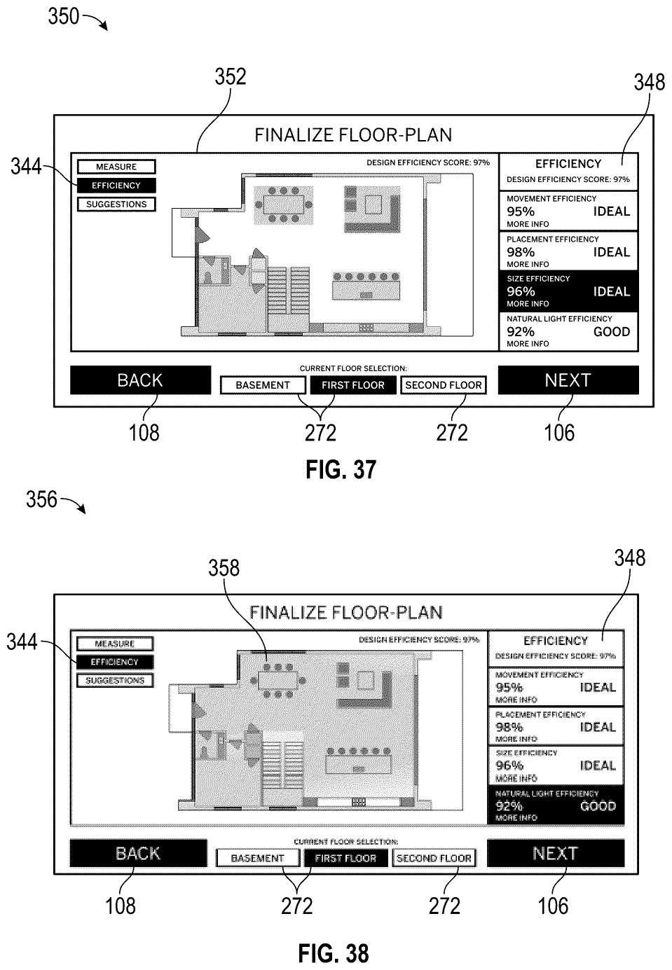

FIG. 37 illustrates a user interface 350 for finalizing a floor plan of the depicted floor plan 352 in which the user has again selected the Efficiency Tool 348, and the Size Efficiency is highlighted. The Size Efficiency is derived from the size of certain elements and objects within a floor plan. As with the other efficiencies, the data for determining size efficiency can be sourced from predetermined parameters as well as baseline sizes for the elements and objects in proportion to the total square footage of the floor plan. Again, the elements or objects may be highlighted from green being the best two red being the worst.

FIG. 38 illustrates a user interface 356 for finalizing a floor plan of the depicted floor plan 358 in which the user again has selected the Efficiency Tool 348, and the Natural Light Efficiency is highlighted. The Natural Light Efficiency is derived from computer modeling that tests the amount of natural light within the floor plan in which the modeling is able to accurately determine the amount of natural light that will reach areas within a floor plan also taking into account the angle and intensity of sunlight that may pass through windows in the building. Again, the elements or objects may be highlighted from green being the best to red being the worst.

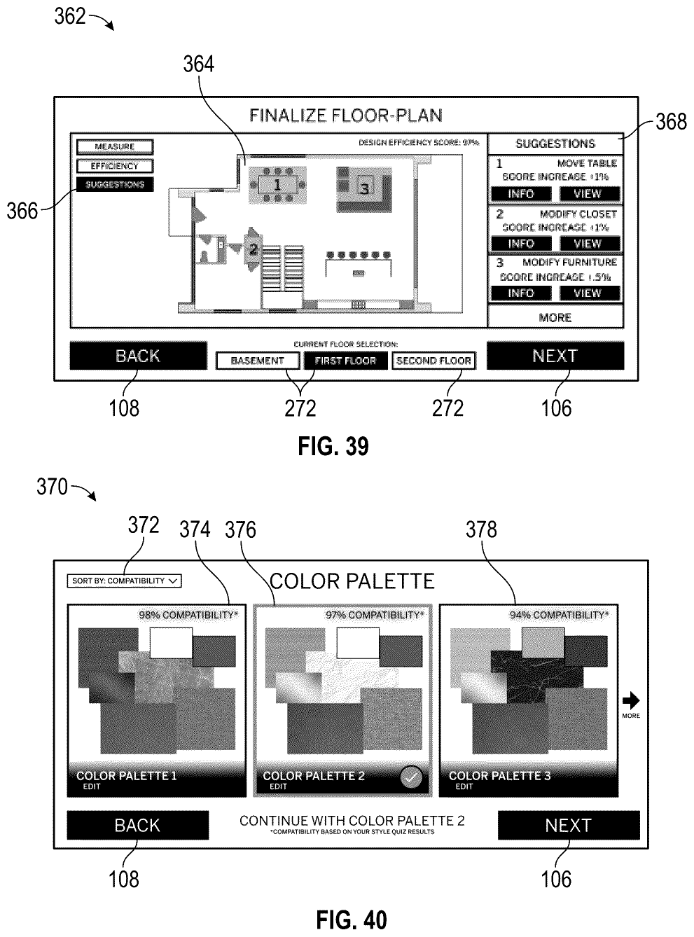

FIG. 39 illustrates a user interface 362 for finalizing a floor plan of the depicted floor plan 364 in which the user has selected the Suggestions Tool 366 and the suggestions for the floor plan are shown in the Suggestions window 368. The Suggestions Tool provides suggestions to the user to improve the design and also shows the efficiency score increases if the illustrated suggestion is adopted. Specifically in this figure, the suggestions are provided with respect to movement of objects in the floor plan, and these suggestions could relate to increasing the movement efficiency of the floor plan. For each suggestion, the user could click on the INFO button to learn more about the suggestion, or the user could click on the VIEW button to see a modified floor plan that adopts the suggestion. As shown, the suggestions can be color-coded in which the suggestion that raises the efficiency score the most is highlighted in red, the suggestion that raises the efficiency score the least is shown in green, and other suggestions that raise the efficiency score are shown in other colors such as blue.

FIG. 40 illustrates a user interface 370 that allows the user to select a color palette from predefined color palettes that may best match the results of the style quiz and other previous user selections. The software may automatically select and generate color palettes as they correspond to the user preferences. As shown in the figure, the user has selected the Color Palette 2, 376. This color palette 376 is shown as having a 97% compatibility score. The two other color palettes shown include Color Palette 1, 374 with a 98% compatibility score, and Color Palette 3, 378 with a 94% compatibility score. This user interface also shows a sort feature 372 in which the user may sort the illustrated colored palettes by various categories such as compatibility, color combinations, or other categories.

FIG. 41 illustrates a user interface 380 in which the selected color palette of FIG. 41 is desired to be modified. As shown in this figure, the user can replace or delete assorted colors or textures and replace them with colors or textures from a predefined list based upon material categories such as stone, wood, or other categories. The selected colors and textures are used later in the design process so the user may view these in the final design renderings. The illustrated color palettes within the window 382 Illustrate that significant detail is provided to the user for selection of colors and textures. When the user has completed editing of the overall color palette, the user may click on the Finish Editing button 384.

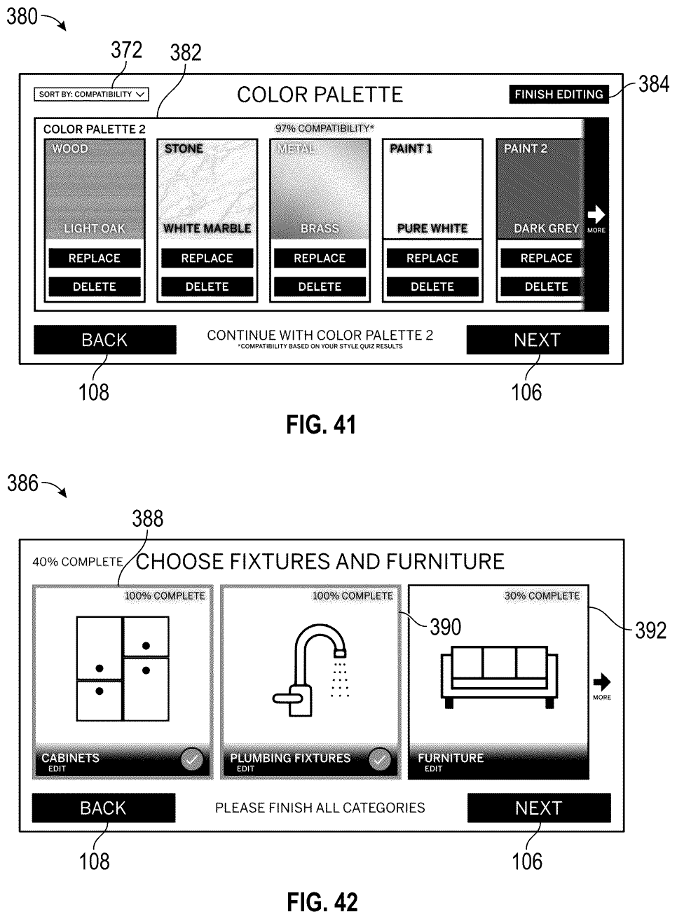

FIG. 42 illustrates a user interface 386 in which interior objects may be selected by the user. Specifically, the interior objects include features including kitchen Cabinets 388, Plumbing Fixtures 390, and Furniture 392. This illustrated step in the design process displays each category of interior objects and the user must click on each object to view the collections within each object. In the illustrated example, the user has clicked on the Cabinets and Plumbing Fixtures features.

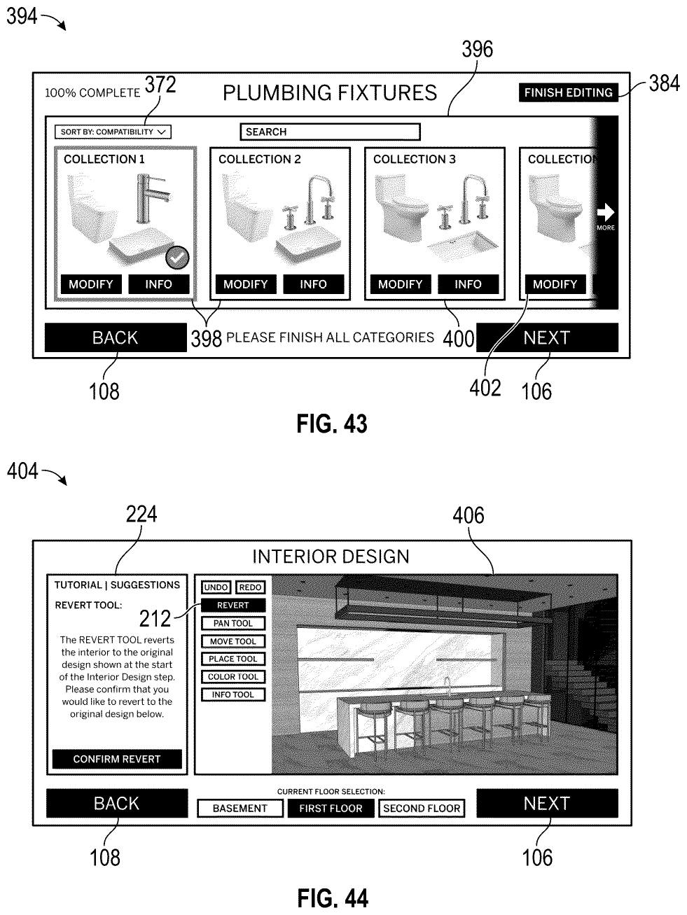

FIG. 43 illustrates a user interface 394 in which the Plumbing Fixtures category is shown within the window 396. In this design step, the user may choose one or more of the collections illustrated. In this example, the user is required to select only one collection, the user selecting the Collection 1 as shown. Within each selected collection, the user may click on the Modify button to mix and match collections or may also search for a certain brand or manufacturer. The user may also click on the Info button in order to review details about the selected collection. The specific objects within each category are initially established by the software to match the colors or textures from the previous design steps. The collections are also sorted by compatibility in which the collections with the highest compatibility are illustrated within the window 396. FIG. 44 also illustrates the Sort by button the 372 in which results may be sorted by other categories. The Finish Editing button 384 is also shown to enable the user to finish editing selection of the plumbing fixtures.

FIG. 44 illustrates a user interface 404 that allows a user to select features of the interior design. In this example, the user selected the first floor of the building and shown within the window 406 is a three-dimensional depiction of a portion of the first floor. The interior design phase includes three-dimensional renderings that the user can pan and move around inside of the image so that the user can obtain a very detailed visual representation of what the interior of the building will look like. Also shown in this figure are the same group of tools available to the user in order to modify the interior design features, noting that in this figure the Revert tool 212 has been selected. In this example, if the user clicks on the Confirm Revert button, the interior design will go back or revert to the original design shown in the start of the design step.

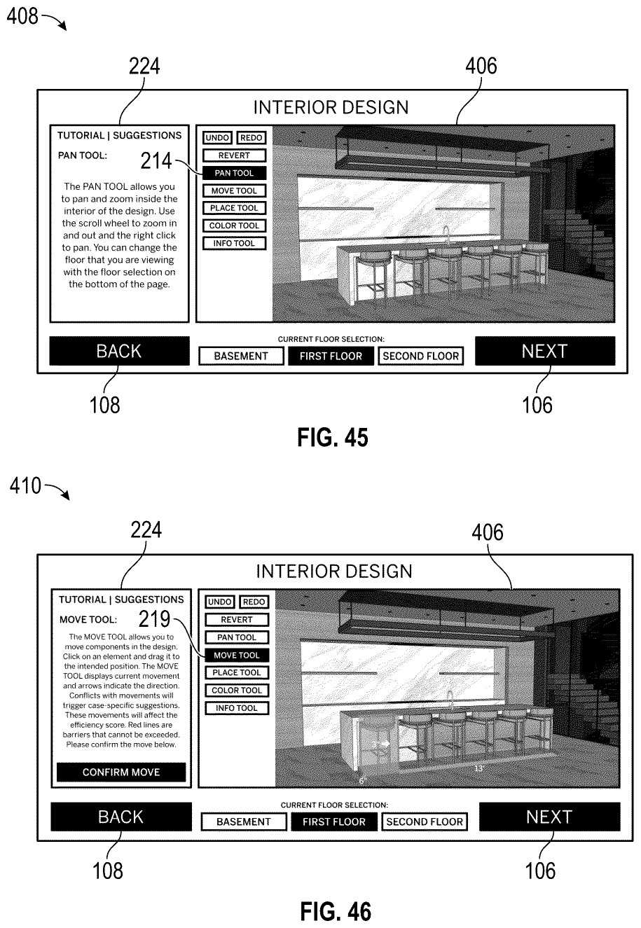

FIG. 45 illustrates a user interface 408 that allows a user to select features and modifications to the interior design and in this example, the user selected the Pan tool 214. The Pan tool in this interior design step allows the user to virtually move around inside the design to pan the interior of the floor. Specifically, the user could use the right click function on a mouse to pan the interior views and use the scroll wheel of the mouse to zoom the view.

FIG. 46 illustrates a user interface 410 that allows a user to select features and modifications to the interior design and in this example, the user selected the Move tool 219. The move tool allows the user to move objects within the interior of the design. Depending upon the object, the move may affect other objects within the design as well. As specifically shown in this example, the user has moved the leftmost barstool to the right three feet and the other bar stools illustrated will be moved automatically within the three-dimensional depiction 406.

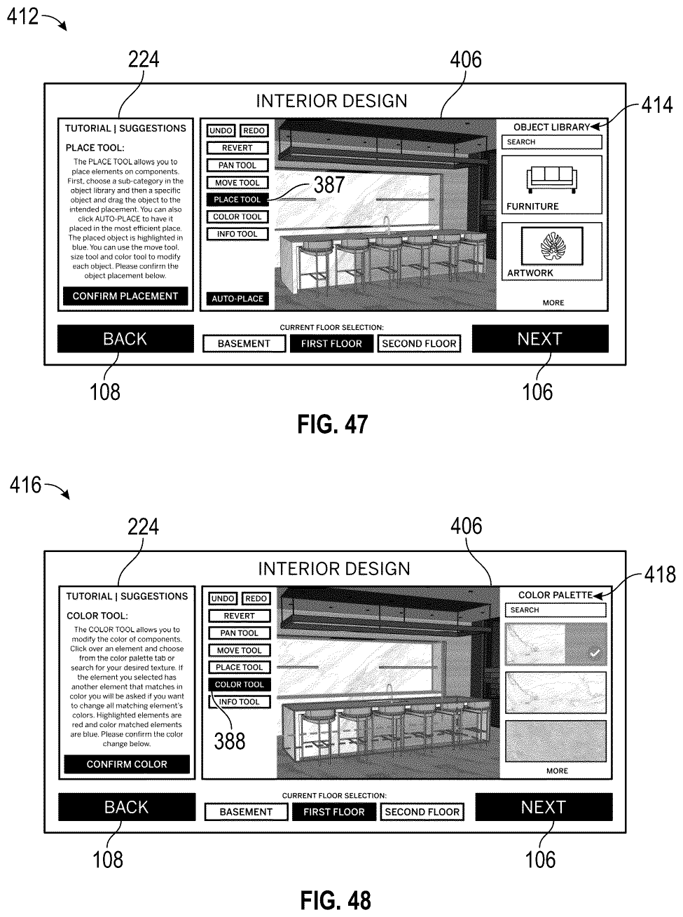

FIG. 47 illustrates a user interface 412 that allows a user to select features and modifications to the interior design and in this example, the user selected the Place tool 387. The Place tool allows the user to place objects within the interior design. An Object Library is shown in the window 414 and may include objects such as doors, furniture, accents, artwork and other interior features. When a user clicks on a specific object category, such as furniture, the user is shown multiple examples of that category. Alternatively, the user may search for objects by selecting the Search tab within the window 414. After selecting an object, the user can then drag the image into the three-dimensional image and the software will then automatically display areas where the object can be placed. These areas may be highlighted in green. The user may also select the Auto Place button that results in the software automatically placing the object in an efficient position. After the object has been placed, the user may optionally select the Size tool or Move tool to modify the size or specific location of the object. The most recently placed object may be highlighted and after the desired placement has been achieved, the user will confirm the placement. By adding an object in an area where other objects are currently placed, the other objects will be automatically moved to another location and then can be later modified by using the Size or Move tools.

FIG. 48 illustrates a user interface 416 that allows a user to select features and modifications to the interior design and in this example, the user selected the Color tool 388. The Color tool is used to modify the color of an object or attribute. The available color palettes are shown in the window 418 and in the example, various textures are illustrated. The corresponding area or features for the color palette at issue are shown in the red outline. The user chooses which feature or object to apply the color tool. The selected feature will be highlighted in the red outline to confirm the color palette to be applied. Alternatively, the user can search for a specific texture or color using the Search tab. If there are two or more matching elements that share the same color in a design, the user can be queried whether the user would like to change the colors of any of those elements. The user will not be asked to change both of those elements if the texture selected is not valid on both attributes. Each attribute or object that is selected will prompt a separate illustrated group of textures in the color palette window 418 based on the case specific colors allowed for that attribute or object.

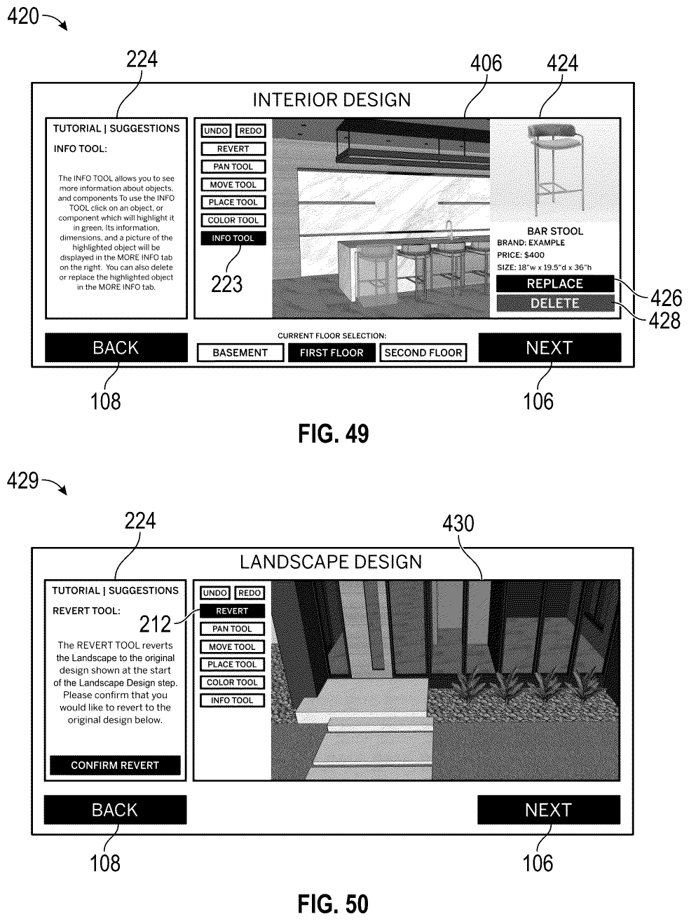

FIG. 49 illustrates a user interface 420 that allows a user to select features and modifications to the interior design and in this example, the user selected the Info tool 223. The Info tool allows the user to select an object to highlight it, then the user is shown current information about that object. As shown, the selected object is a bar stool and information about the bar stool is depicted in the window 424. The type of information that can be illustrated may include the brand, price, and size of the object. The user may also replace an object by using the Place tool (add reference number). The user may again view specific information about the replaced object by again selecting the Info tool. This iterative process of viewing and replacing or deleting objects provides the user with great flexibility in choosing an interior design and objects or elements within the interior design.

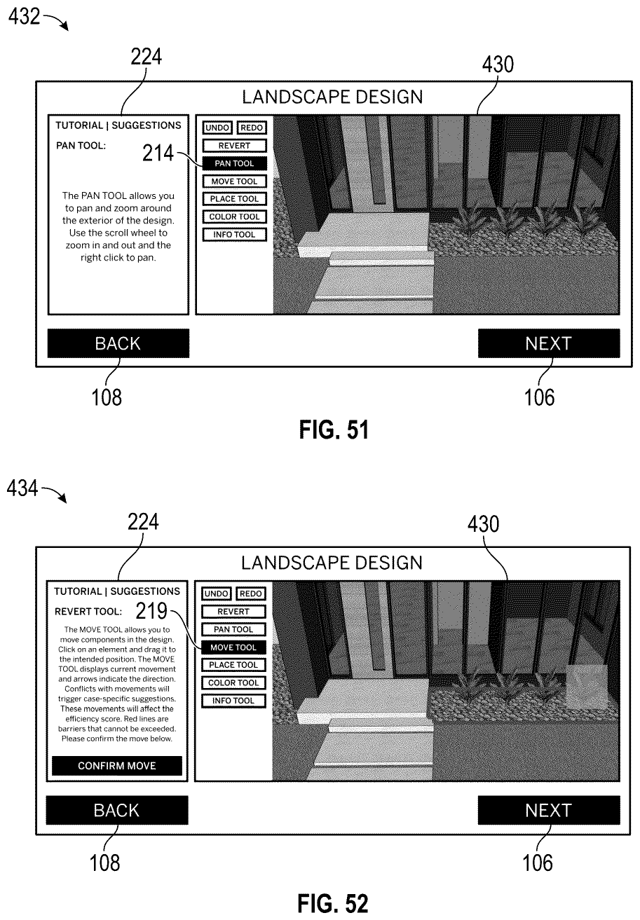

FIG. 50 is a sample user interface 429 that allows a user to modify the landscape design and in which the same tools are made available for modifying the landscape design as were available for modifying the exterior, modifying the floor plans, and modifying the interior. The Revert tool 212 is selected in the FIG. 51 and the other tools are also shown (Randomize, Size, Move, Place and Information tools). FIG. 51 specifically shows the landscaping around the front entrance of the building in window 430. Similar to the interior design steps, the user will view a three-dimensional depiction of the exterior of the building and the surrounding landscaping. If the user wishes to revert to the original design, then the user will select the Confirm Revert button.

FIG. 51 is a sample user interface 432 that allows a user to modify the landscape design in which the user selected the Pan tool 214. The same functionality is provided for this landscape design step and use of the Pan tool as described for the other design steps. Selecting this tool allows the user to traverse the exterior of the building and to view landscaping from all sides of the building.

FIG. 52 is a sample user interface 434 that allows a user to modify the landscape design in which the user selected the Move tool 219. The same functionality is provided for this landscape design step and use of the Move tool as described for the other design steps. Selecting this tool allows the user to move objects within the design. Depending upon the object selected and the location in which the object is to be moved, this movement may affect other objects. In the illustrated example, the user has selected the rightmost plant that is highlighted in green, and the other plants will be automatically moved based upon the selected movement of the rightmost plant. The area affected is shown in the red outline and each designated area of a landscape may be separated into respective areas so that the user may more conveniently.

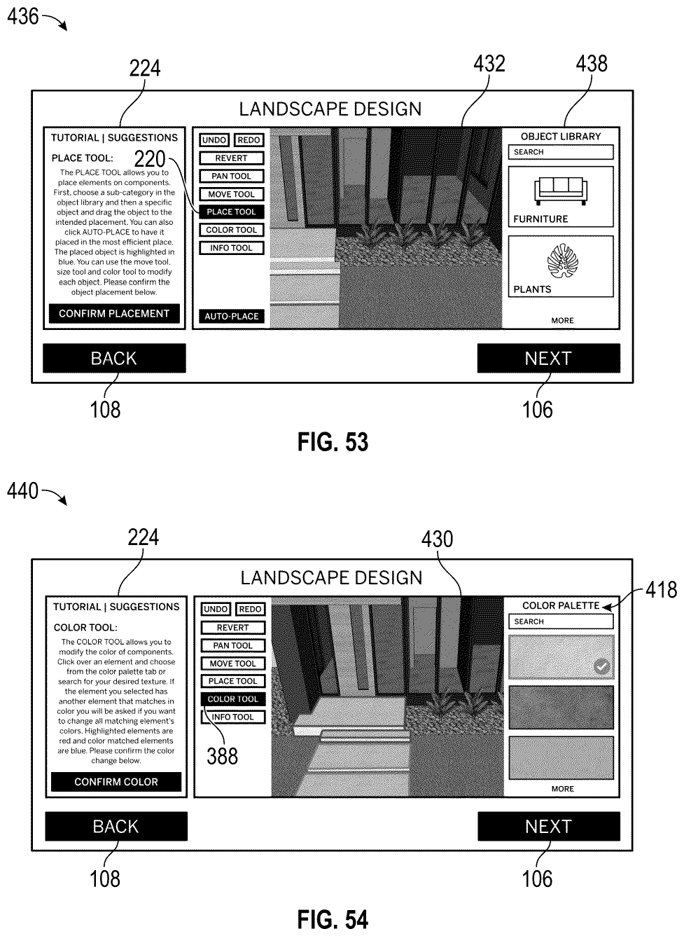

FIG. 53 is a sample user interface 436 that allows a user to modify the landscape design in which the user selected the Place tool 220. The same functionality is provided for this landscape design step and use of the Place tool as described for the other design steps. An object library is shown in the window 438 that allows the user to select specific objects to incorporate in the landscape design. The illustrated objects in this user interface include outdoor furniture and plants. Other features could include accents and landscaping geometries such as the specific slope or angle of the property surrounding the building. If the user clicks on a category such as furniture, again the user will be shown multiple versions of that category and then the user can choose the specific objects within the category. Additionally, by clicking on the search tab, the user may choose from other objects. After choosing the desired object, the user will drag the object into the design and then the software will automatically display the area that the object can be placed, such as highlighting the area in green. Again, the user may also select the Auto Place option in which the software will then automatically place the object in the most efficient position. After the object has been placed the user can again use the Size tool and Move tool in order to modify the size or specific location of the object selected. The most recently placed object can be highlighted in blue and after the desired placement has been achieved, the user can confirm the placement by clicking on the Confirm Placement button.

FIG. 54 is a sample user interface 440 that allows a user to modify the landscape design in which the user selected the Color tool 338. The color tool is used to modify the color of an object or attribute selected by the user. A color palette is shown within window 418 and the user can choose the desire to color or texture from those shown in the palette. Alternatively, the user may also search for a specific color or texture using the Search tab. If there are two or more matching elements or objects that share the same color or texture in a design, the user can be queried as to whether the user would like to change the texture or colors of one or both of the elements. The user will not be queried to change both of the elements if the texture that is chosen by the user is not valid for both elements or objects. Each attribute or object that is clicked on in the three-dimensional image will prompt a separate color palette based upon case specific colors or textures allowed for the selected attribute or object. Certain objects such as plants will obviously not have the color tool option because the plant inherently will have its own natural color. Specifically shown in this user interface is the user's selection of the front porch and sidewalk leading up to the front porch for the color modification. Further in this example, the user selected the top color or texture in the window 418 for both the front porch and sidewalk.

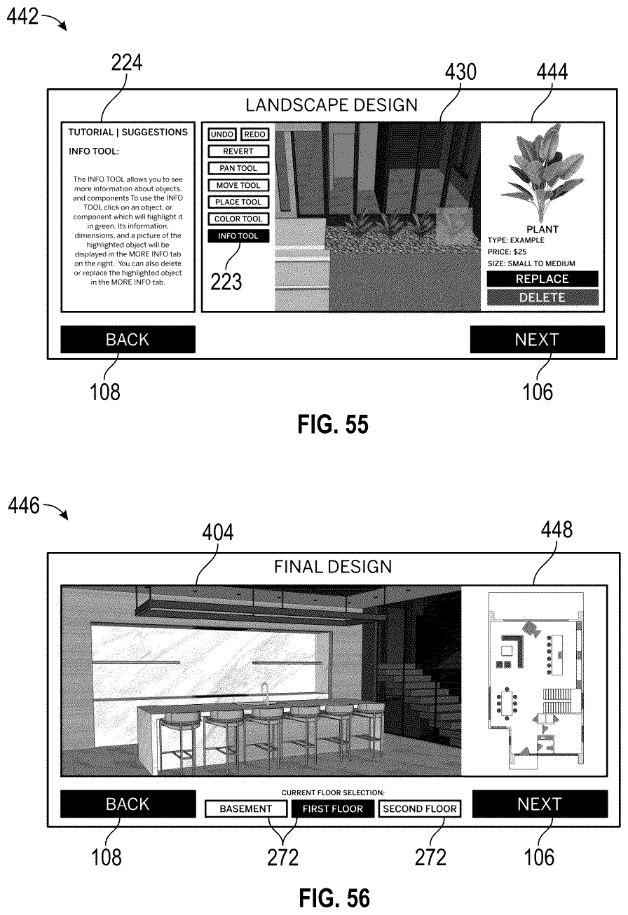

FIG. 55 is a sample user interface 442 that allows a user to modify the landscape design in which the user selected the Info tool 223. As with selection of the Info tool for the other design steps, the user clicks on the object of interest and the user will then be displayed current information about the selected object in the window 444. In the example illustrated, the user selected a plant and the information provided for the plant includes a visual depiction of the plant, a price, and a size category. Again, the user can replace or delete an item using the Replace or Delete buttons. Alternatively, the user can edit the item by using the Replace button.

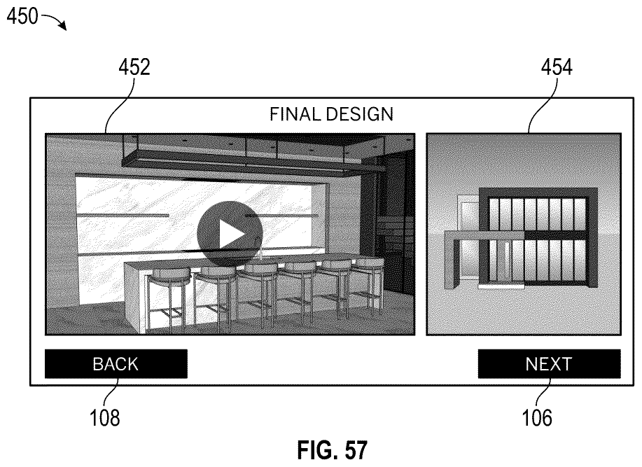

FIG. 56 is a sample user interface 446 that allows the user to review and approve the entire final design for the building to include the interior, exterior, and landscaping. FIG. 57 specifically shows a final design for the interior first floor of the building, along with a two-dimensional floor plan shown in window 448. The user may move a cursor to any location within the depicted three-dimensional design and then pan around the design to view the final design in three-dimensional renderings. The specific location of the pan location may be simultaneously shown in the accompanying floor plan located on the same user interface, shown with the blue colored camera icon. As the user moves within the three-dimensional renderings, the camera icon will also show where the user is currently located within the design.

FIG. 57 is a sample user interface that allows the user to review and approve the entire final design for the building to include the interior, exterior, and landscaping in which the user interface provides a predetermined or preconfigured three-dimensional video along with multiple images of the design. The user may be provided a link to share the images and videos on social media or other electronic means.

The foregoing described user interfaces or screenshots provide details on various design steps that can be incorporated within the method and product of the current invention. It should be understood however that the method and product of the invention may be considered as having multiple embodiments in which discrete design steps can be considered other embodiments of the invention. Therefore, the overall design process as described can be considered multiple embodiments in a multitude of combinations and sub-combinations in which selected user interfaces or screenshots make up the various combinations and sub-combinations. For example, a user may have already selected an existing building but wishes to redesign the interior of the building. In this example, the invention can be used as an interior design process and therefore, landscaping and exterior design are not required to be included.

It should also be apparent that the invention described herein provides the user with detailed options for selecting and modifying a design for a building. Each of the options have been illustrated with corresponding user interfaces or screenshots, but it should also be understood that the functionality shown in each of the screenshots is not static, and the functionality for multiple screenshots could be incorporated into a single screenshot for purposes of simplifying the design process.

While the invention has been described herein with respect to various embodiments including combinations and sub-combinations, it should be understood that the invention should be broadly viewed commensurate with the overall scope of the appended claims and figures which accompany the description.

What is claimed is:

1. A computer-implemented method for designing features of a building, wherein a user of the method desires to build or purchase the building to be built and said method enabling creation of a final design, said method comprising the steps of:
providing a non-transitory computer-readable medium containing computer executable instructions, wherein, when executed by a computer processor, the instructions cause the computer processor to execute the method of designing the custom building;
providing at least one database that is accessible by the computer processor and said at least one database having data objects that include at least one of (1) two-dimensional images of components of the building, (2) three-dimensional images of components of the building and (3) descriptions of components of the building, and said data objects being viewable on a plurality of user interface screens associated with the computer, and wherein said components include features of the building including at least one of interior features, exterior features, landscaping features, and floor plans of the building to be built;
providing a plurality of user interfaces containing questions regarding details of the user preferences enabling the user to input preferences to the questions that are recorded in the at least one database, said questions including queries to the user as to specific attributes or styles that the user wishes to adopt in the design of the building;
associated logic within the computer executable instructions that is responsive to the preferences submitted by the user wherein the preferences are matched with data objects that reflect the preferences;
providing another user interface that shows at least one of the two or three-dimensional images of components of the building that include the matched data objects;
providing another user interface that allows the user to change the preferences and subsequently resulting in another user interface provided that shows the changed preferences;
executing instructions from the user to repetitively revise and to then finalize the design; and
providing another user interface that allows the user to view three dimensional images of the final design.

2. The method of claim 1, wherein:
The data objects viewable by the user include at least one of: interior rooms of the custom building, exterior categorized design types, furniture, appliances, interior room arrangements shown as floor plans, color palettes, and landscape designs.

3. The method of claim 1, wherein:
a user uploads photographs to the computer readable medium and said photographs become data objects so that the user may utilize the photographs as supplemental data objects for any one of the interior features, exterior features, landscaping features, and floor plans.

4. The method of claim 3, wherein:
said computer readable medium includes logic which allows photo recognition such that uploaded photos can be identified as corresponding to distinct elements of corresponding data objects, and further wherein the distinct elements are thereby incorporated within designs options for the user.

5. The method of claim 1, further including:
creating architectural plans and construction plans from the final design; and
constructing the building from the architectural and construction plans.

6. The method of claim 1, further including:
creating landscaping plans from the final design; and
creating landscaping for the building from the landscaping plans.

7. A computer program product that executes a computer-implemented method for designing features of a building, wherein a user of the method desires to build or purchase the building to be built and said method enabling creation of a final design, said computer program product comprising:
a non-transitory computer-readable medium containing computer executable instructions, wherein, when executed by a computer processor, the instructions cause the computer processor to execute the computer implemented method of the product;
computer readable instructions to receive and store data in at least one database having data objects that correspond to two-dimensional and three-dimensional images of components of the building when viewed on a user interface screen associated with a display of a computer that incorporates said data processor, wherein said components include features of at least one of an interior, exterior, landscaping and floor plans of the building to be built;
computer readable instructions to generate questions shown to the user regarding details of the building and these questions enabling a user to input preferences to the questions that are recorded in the at least one database, said questions including queries to the user as to specific attributes or styles that the user wishes to adopt in the design of the building;
associated logic within the computer executable instructions that is responsive to the preferences submitted by the user wherein the preferences are matched with data objects that reflect the preferences;
providing another user interface that shows at least one of the two or three-dimensional images of components of the building that include the matched data objects;
providing another user interface that allows the user to change the preferences and subsequently resulting in another user interface provided that shows the changed preferences;
executing instructions from the user to repetitively revise and to then finalize the design; and
providing another user interface that allows the user to view three dimensional images of the final design.

8. The computer program product of claim 7 wherein:
the data objects viewable by the user include at least one of: interior rooms of the custom building, exterior categorized design types, furniture, appliances, interior room arrangements shown as floor plans, color palettes, and landscape designs.

9. The computer program product of claim 7, wherein:
a user uploads photographs to the computer readable medium and said photographs become data objects so that the user may utilize the photographs as supplemental data objects for any one of the interior features, exterior features, landscaping features, and floor plans.

10. The computer program product of claim 7, wherein:
said computer readable medium includes logic which allows photo recognition such that uploaded photos can be identified as corresponding to distinct elements of corresponding data objects, and further wherein the distinct elements are thereby incorporated within designs options for the user.

11. A computer-implemented method for designing features of a building as directed by a user who executes the method to create a plurality of iterative intermediate designs and a final design, said method comprising the steps of:
providing a non-transitory computer-readable medium containing computer executable instructions, wherein, when executed by a computer processor, the instructions cause the computer processor to execute the method of designing the custom building,
providing at least one database that is accessible by the computer processor and said at least one database having data objects that corresponds to two-dimensional and three-dimensional images of components of the building when viewed on a user interface screen associated with the computer, wherein said components include features of at least one of an interior, exterior, landscaping and floor plans of the building to be built;
providing a user interface with questions regarding details of the building and these questions enabling a user to input preferences to the questions that are recorded in the at least one database, said questions including queries to the user as to specific attributes or styles that the user wishes to adopt in the design of the building;
associated logic within the computer executable instructions that is responsive to the preferences submitted by the user wherein the preferences are matched with data objects that reflect the preferences;
providing another user interface that shows at least one of the two or three-dimensional images of components of the building that include the matched data objects;
providing another user interface that allows the user to change the preferences and subsequently resulting in another user interface provided that shows the changed preferences, the changed preferences being viewable as intermediate designs; and
executing instructions from the user to repetitively revise and to then finalize the design.

12. The method of claim 11, wherein:
The data objects viewable by the user include at least one of: interior rooms of the custom building, exterior categorized design types, furniture, appliances, interior room arrangements shown as floor plans, color palettes, and landscape designs.

13. The method of claim 11, wherein:
a user uploads photographs to the computer readable medium and said photographs become data objects so that the user may utilize the photographs as supplemental data objects for any one of the interior features, exterior features, landscaping features, and floor plans.

14. The method of claim 11, wherein:
said computer readable medium includes logic which allows photo recognition such that uploaded photos can be identified as corresponding to distinct elements of corresponding data objects, and further wherein the distinct elements are thereby incorporated within designs options for the user.

15. The method of claim 11, further including:
creating architectural plans and construction plans from the final design; and
constructing the building from the architectural and construction plans.

16. The method of claim 11, further including:
creating landscaping plans from the final design; and
creating landscaping for the building from the landscaping plans.

17. A computer-implemented method for designing features of a building, wherein a user of the method desires to build or purchase the building to be built and said method enabling creation of a final design, said method comprising the steps of:
providing a non-transitory computer-readable medium containing computer executable instructions, wherein, when executed by a computer processor, the instructions cause the computer processor to execute the method of designing the custom building,
providing at least one database that is accessible by the computer processor and said at least one database having data objects that include at least one of (1) two-dimensional images of components of the building, (2) three-dimensional images of components of the building and (3) descriptions of components of the building, said data objects being viewable on a plurality of user interface screens associated with the computer, and wherein said components include features of the building including at least one of interior features, exterior features, landscaping features, and floor plans of the building to be built;
providing a plurality of data objects of two-dimensional images features of the building in said database that are recorded as corresponding to one or more specific styles;
providing a plurality of user interfaces containing style questions to the user regarding details of user preferences for features to be incorporated in the building;
recording the user preferences in the at least one database wherein the questions may include two-dimensional images of the features of the building shown to the user on user interfaces;
determining by said computer which images in said data base provide closest style matches as compared to the user preferences wherein the user preferences are numerically quantified as corresponding to one or more the data object styles recorded in the database;
executing logic within the computer executable instructions that is responsive to preferences submitted by the user wherein the preferences are matched with data objects that match the user preferences;
providing another user interface that shows at least one of the two or three-dimensional images of components of the building that include the matched data objects;
providing another user interface that allows the user to change the preferences and subsequently resulting in another user interface provided that shows the changed preferences;
executing instructions from the user to repetitively revise and to then finalize the preferences to create the final design; and
providing another user interface that allows the user to view three dimensional images of the final design.

18. The method of claim 17, further including:
creating architectural plans and construction plans from the final design; and
constructing the building from the architectural and construction plans.

19. The method of claim 17, further including:
creating landscaping plans from the final design; and
creating landscaping for the building from the landscaping plans.

20. A computer-implemented method for designing features of a man-made structure having interior and exterior features that can be occupied by one or more persons, said method comprising the steps of:
providing a non-transitory computer-readable medium containing computer executable instructions, wherein, when executed by a computer processor, the instructions cause the computer processor to execute the method of designing the structure;
providing at least one database that is accessible by the computer processor and said at least one database having data objects that include at least one of (1) two-dimensional images of the structure, (2) three-dimensional images of components of the structure, and (3) descriptions of components of the structure, and said data objects being viewable on a plurality of user interface screens associated with the computer, and wherein said components include features of the structure including at least one of interior features and exterior features;
providing a plurality of user interfaces containing questions regarding details of the user preferences enabling the user to input preferences to the questions that are recorded in the at least one database, said questions including queries to the user as to specific attributes or styles that the user wishes to adopt in the design of the structure;
associated logic within the computer executable instructions that is responsive to the preferences submitted by the user wherein the preferences are matched with data objects that reflect the preferences;
providing another user interface that shows at least one of the two or three-dimensional images of components of the structure that include the matched data objects;
providing another user interface that allows the user to change the preferences and subsequently resulting in another user interface provided that shows the changed preferences;
executing instructions from the user to repetitively revise and to then finalize a design of the structure wherein each revision automatically results in defined parameters being recalculated each time revisions are made, said parameters including at least one of a cost of the structure, a bill of materials for the structure, a square footage of the structure and a footprint of the structure as displayed in an exterior view of the structure or a floor plan of the structure.

21. The method of claim 20, further including:
a user selectable randomize tool on a user interface enabling a user to incorporate shell logic parameters for a chosen shell previously entered by the user to change attributes of the interior or exterior.

22. The method of claim 20, further including:
a user selectable pan tool on a user interface enabling a user to pan and zoom around a virtual three-dimensional image of the interior or exterior of the structure.

23. The method of claim 20, further including:
a user selectable size tool on a user interface enabling a user to modify the size, thickness of structural components of the interior or exterior and further wherein the user interface displays ae current size of the components and one or more selected size changes.

24. The method of claim 20, further including:
a user selectable move tool on a user interface enabling a user to move components in the interior or exterior and wherein the move tool allows the move or inhibits the move if the movement goes beyond allowable design parameters.

25. The method of claim 20, further including:
a user selectable place tool on a user interface enabling a user to place additional components on the interior or exterior and wherein the additional components are rendered on the user interface for the user to see.

26. The method of claim 20, further including:
a user selectable color tool on a user interface enabling a user to modify a color of a component or to modify other attributes of the component such as a type of finish, texture, or other visible characteristic.

27. A computer program product that executes a computer-implemented method for designing features of a man-made structure having interior and exterior features that can be occupied by one or more persons, said method comprising the steps of:
a non-transitory computer-readable medium containing computer executable instructions, wherein, when executed by a computer processor, the instructions cause the computer processor to execute the computer implemented method of the product;
computer readable instructions to receive and store data in at least one database having data objects that correspond to two-dimensional and three-dimensional images of components of the structure when viewed on a user interface screen associated with a display of a computer that incorporates said data processor, wherein said components include features of at least one of an interior and exterior of the structure;
computer readable instructions to generate questions shown to the user regarding details of the structure and these questions enabling a user to input preferences to the questions that are recorded in the at least one database, said questions including queries to the user as to specific attributes or styles that the user wishes to adopt in the design of the structure;
associated logic within the computer executable instructions that is responsive to the preferences submitted by the user wherein the preferences are matched with data objects that reflect the preferences;
providing another user interface that shows at least one of the two or three-dimensional images of components of the structure that include the matched data objects,
providing another user interface that allows the user to change the preferences and subsequently resulting in another user interface provided that shows the changed preferences;
executing instructions from the user to repetitively revise and to then finalize the design; and

28. The computer program product of claim 27, further including:
a user selectable randomize tool on a user interface enabling a user to incorporate shell logic parameters for a chosen shell previously entered by the user to change attributes of the interior or exterior.

29. The computer program product of claim 27, further including:
a user selectable pan tool on a user interface enabling a user to pan and zoom around a virtual three-dimensional image of the interior or exterior of the structure.

30. The computer program product of claim 27, further including:
a user selectable size tool on a user interface enabling a user to modify the size, thickness of structural components of the interior or exterior and further wherein the user interface displays ae current size of the components and one or more selected size changes.

31. The computer program product of claim 27, further including:
a user selectable move tool on a user interface enabling a user to move components in the interior or exterior and wherein the move tool allows the move or inhibits the move if the movement goes beyond allowable design parameters.

32. The computer program product of claim 27, further including:
a user selectable place tool on a user interface enabling a user to place additional components on the interior or exterior and wherein the additional components are rendered on the user interface for the user to see.

33. The computer program product of claim 27, further including:
a user selectable color tool on a user interface enabling a user to modify a color of a component or to modify other attributes of the component such as a type of finish, texture, or other visible characteristic.

34. A computer-implemented method for designing features of a man-mad structure comprising the steps of:
providing a non-transitory computer-readable medium containing computer executable instructions, wherein, when executed by a computer processor, the instructions cause the computer processor to execute the method of designing the custom building;
providing at least one database that is accessible by the computer processor and said at least one database having data objects that include at least one of (1) two-dimensional images of components of the structure (2) three-dimensional images of components of the structure and (3) descriptions of components of the structure, and said data objects being viewable on a plurality of user interface screens associated with the computer, and wherein said components include features of the structure including at least one of interior features, exterior features, landscaping features, and floor plans of the structure to be built;
providing a plurality of user interfaces containing questions regarding details of the user preferences enabling the user to input preferences to the questions that are recorded in the at least one database, said questions including queries to the user as to specific attributes or styles that the user wishes to adopt in the design of the structure;
associated logic within the computer executable instructions that is responsive to the preferences submitted by the user wherein the preferences are matched with data objects that reflect the preferences and wherein the data objects are matched on a percentage basis to provide a most optimum match;
providing another user interface that shows at least one of the two or three-dimensional images of components of the structure that include the matched data objects;
executing instructions from the user to repetitively revise the design; and
providing another user interface that allows the user to view three dimensional images of the design.

35. A computer program product that executes a computer-implemented method for designing features of a man-made structure, said computer program product comprising:
a non-transitory computer-readable medium containing computer executable instructions, wherein, when executed by a computer processor, the instructions cause the computer processor to execute the computer implemented method of the product;
computer readable instructions to receive and store data in at least one database having data objects that correspond to two-dimensional and three-dimensional images of components of the structure when viewed on a user interface screen associated with a display of a computer that incorporates said data processor, wherein said components include features of at least one of an interior and exterior of the structure to be built;
computer readable instructions to generate questions shown to the user regarding details of the structure and these questions enabling a user to input preferences to the questions that are recorded in the at least one database, said questions including queries to the user as to specific attributes or styles that the user wishes to adopt in the design of the structure;
associated logic within the computer executable instructions that is responsive to the preferences submitted by the user wherein the preferences are matched with data objects that reflect the preferences;
wherein the user preferences and data objects are matched by a percentage basis in order to provide a best match;
providing another user interface that shows at least one of the two or three-dimensional images of components of the structure that include the matched data objects;
executing instructions from the user to repetitively revise the design; and
providing another user interface that allows the user to view three dimensional images of the design.
